(19) United States
(12) Patent Application Publication
(10) Pub. No.: US 2009/0296549 A1
(43) Pub. Date: Dec. 3, 2009

(54) Optical Disk Device

(76) Inventors: Kei Kobayashi, Osaka (JP); Masayoshi Igarashi, Osaka (JP); Yoshihiro Kanda, Kyoto (JP)

Correspondence Address: WENDEROTH, LIND & PONACK L.L.P., 1030 15th Street, N.W., Suite 400 East, Washington, DC, 20005-1503, US

(21) Appl. No.: 12/130,801

(22) Filed: May 30, 2008

(51) Int. Cl. G11B 7/00; G11B 5/58

(52) U.S. Cl. 369/53.17

(57) ABSTRACT

The precision of a direction detection signal DIR is judged from the duty ratio of the direction detection signal DIR, and the direction detection signal DIR which is used for track search control or tracking pull-in control is judged as valid or invalid according to the precision, thereby to improve the precision of the track search control or the tracking pull-in control. Therefore, even when the direction detection is not performed accurately due to a difference in the reflected light quantity on the optical disk, a defect on the optical disk, a delay in the track cross speed during search, or a delay in the detection circuit, the track search control and the tracking pull-in control can be performed with stability.

### FIELD OF THE INVENTION

The present invention relates to an optical disk device, and more particularly, to an optical disk device including a track searching circuit for moving a light beam spot onto a desired track by using an actuator and a traverse, and a tracking pull-in circuit for making the light beam spot follow a desired track.

### BACKGROUND OF THE INVENTION

In recent years, optical disk devices for recording or reproducing data in/from optical disks having spiral tracks, such as a CD (Compact Disk), a MD (Mini Disk), a DVD (Digital Versatile Disk) and a BD (Blue-ray Disk), have been developed. These optical disk devices perform tracking control for controlling a light beam spot so as to be constantly positioned on a track, and track search control for operating the tracking control when the light beam spot reaches a desired track while moving the light beam spot in the radial direction of the optical disk.

While the position of the light beam spot during the track search is obtained by counting track cross signals from the start of the track search, when the moving speed of the light beam spot is low such as when the search is started or when the light beam spot approaches a target track, the light beam spot often runs reversely on the track due to eccentricity of the disk or vibration of the tracking actuator, which causes an error between the current position of the light beam spot and the calculated value of the track cross signal.

In order to solve this problem, a signal indicating the direction in which the light beam spot advances with respect to the track (hereinafter referred to as “a direction detection signal”) is detected from the track cross signal and the off-track signal, and the number of the track cross signals is reduced when the light beam spot reversely runs on the track, thereby preventing occurrence of an error between the current position of the light beam spot and the calculated value of the track cross signal.

Further, the control band of the tracking control is usually about several KHz, and the tracking pull-in capability has a limitation. So, speed control is performed so that the speed of the light beam spot when it enters the target track becomes a speed suitable for the tracking pull-in.

However, there is a problem that the light beam spot is not pulled in the target track due to eccentricity of the disk or vibration of the tracking actuator, and considerably overruns to be pulled in another track, thereby taking time to return the light beam spot back to the target track. So, in order to minimize the amount of overrunning of the light beam spot during the tracking pull-in, a brake pulse is applied to the light beam spot using the direction detection signal during the tracking pull-in, thereby decelerating the relative speed between the light beam spot and the track.

However, while it is effective to use the direction detection signal as the basis in the access circuit performing the track search control and the tracking pull-in circuit, if the direction detection is not correctly performed due to a difference in the reflected light quantity on the optical disk, a defect on the optical disk, a delay in the track cross speed during the track search, or a delay in the detection circuit, there might occur a fatal problem that the counting of the number of track crosses fails and the track search control is not terminated, or that the decelerating of the relative speed between the light beam spot and the track fails and the tracking pull-in cannot be performed.

Patent Document 1: Japanese Published Patent Application No. Hei. 8-55346

Patent Document 2: Japanese Published Patent Application No. 2000-331353

### SUMMARY OF THE INVENTION

The present invention is made to solve the above-described problems and has for its object to provide an optical disk device which can realize stable track search control and stable tracking pull-in control even when there is a difference in the reflected light amount on the optical disk, a defect on the optical disk, a delay in the track cross speed during the track search, or a delay in the detection circuit.

Other objects and advantages of the invention will become apparent from the detailed description that follows. The detailed description and specific embodiments described are provided only for illustration since various additions and modifications within the scope of the invention will be apparent to those of skill in the art from the detailed description.

According to a first aspect of the present invention, an optical disk device comprises a light beam spot for irradiating a track on an optical disk with laser light to receive reflected light of the laser light, an actuator for moving the light beam spot in a radial direction of the optical disk, a traverse for moving the light beam spot and the actuator in the radial direction of the optical disk, a tracking error detection circuit for detecting a tracking error signal on the basis of the reflected light of the laser light, a track cross signal detection circuit for detecting a track cross signal on the basis of the tracking error signal, an off-track signal detection circuit for detecting an off-track signal on the basis of the reflected light of the laser light, a direction detection circuit for detecting a direction detection signal which indicates the moving direction of the light beam spot with respect to the optical disk, on the basis of the track cross signal and the off-track signal, a track searching circuit performing track search for moving the light beam spot onto a desired track by driving the actuator and the traverse, a tracking pull-in circuit performing tracking control for making the light beam spot follow a desired track by driving the actuator, a duty ratio measurement circuit for measuring a duty ratio of the direction detection signal, and a switching circuit for validating the direction detection signal when the duty ratio of the direction detection signal that is measured while the tracking control is off is within a predetermined range of threshold values, and invalidating the direction detection signal when the duty ratio of the direction detection signal is outside the predetermined range, wherein, when the direction detection signal is valid, the track searching circuit performs the track search using the direction detection signal, and the tracking pull-in circuit performs the tracking control using the direction detection signal. Therefore, it is possible to determine whether the direction detection signal should be used or not for the track search control or the tracking pull-in control, in accordance with the result of the judgment on the reliability of the light beam spot moving direction that is indicated by the direction detection signal, thereby realizing stable track search and stable tracking pull-in control even when the direction detection is not correctly performed due to a difference in reflected light amount on the optical disk, a defect on the optical disk, a delay in the track cross speed during the track search, or a delay in the detection circuit.

According to a second aspect of the present invention, in the optical disk device according to the first aspect, the switching circuit validates the direction detection signal when the duty ratio is within a range from 40% to 60%. Therefore, the reliability of the direction detection signal can be judged more accurately on the basis of the duty ratio of the direction detection signal.

According to a third aspect of the present invention, an optical disk device comprises a light beam spot for irradiating a track on an optical disk with laser light to receive reflected light of the laser light, an actuator for moving the light beam spot in a radial direction of the optical disk, a traverse for moving the light beam spot and the actuator in the radial direction of the optical disk, a tracking error detection circuit for detecting a tracking error signal on the basis of the reflected light of the laser light, a track cross signal detection circuit for detecting a track cross signal on the basis of the tracking error signal, an off-track signal detection circuit for detecting an off-track signal on the basis of the reflected light of the laser light, a direction detection circuit for detecting a direction detection signal which indicates the moving direction of the light beam spot with respect to the optical disk, on the basis of the track cross signal and the off-track signal, a track searching circuit performing track search for moving the light beam spot onto a desired track by driving the actuator and the traverse, a tracking pull-in circuit performing tracking control for making the light beam spot follow a desired track by driving the actuator, a period measurement circuit for measuring a period of the direction detection signal, and a switching circuit for validating the direction detection signal when the ratio of the period of the direction detection signal that is measured while the tracking control is off to the rotation period of the disk is within a predetermined range of threshold values, and invalidating the direction detection signal when the ratio is outside the predetermined range, wherein, when the direction detection signal is valid, the track searching circuit performs the track search using the direction detection signal, and the tracking pull-in circuit performs the tracking control using the direction detection signal. Therefore, the reliability of the direction detection signal can be judged on the basis of the rotation period that is usually measured in the optical disk device, thereby reducing the time required for the judgment.

According to a fourth aspect of the present invention, in the optical disk device according to the third aspect, the switching circuit validates the direction detection signal when the ratio of the period of the direction detection signal to the rotation period of the disk is within a range from 90% to 110%. Therefore, the reliability of the direction detection signal can be judged more accurately by using the rotation period of the optical disk.

According to a fifth aspect of the present invention, an optical disk device comprises a light beam spot for irradiating a track on an optical disk with laser light to receive reflected light of the laser light, an actuator for moving the light beam spot in a radial direction of the optical disk, a traverse for moving the light beam spot and the actuator in the radial direction of the optical disk, a tracking error detection circuit for detecting a tracking error signal on the basis of the reflected light of the laser light, a track cross signal detection circuit for detecting a track cross signal on the basis of the tracking error signal, an off-track signal detection circuit for detecting an off-track signal on the basis of the reflected light of the laser light, a track searching circuit performing track search for moving the light beam spot onto a desired track by driving the actuator and the traverse, a tracking pull-in circuit performing tracking control for making the light beam spot follow a desired track by driving the actuator, a direction detection circuit for detecting a direction detection signal which indicates the moving direction of the light beam spot with respect to the optical disk, on the basis of the track cross signal and the off-track signal, a lens shift circuit for shifting the light beam spot in the radial direction of the optical disk, and a switching circuit for validating the direction detection signal when the direction in which the light beam spot is shifted by the lens shift circuit matches the moving direction of the light beam spot that is indicated by the direction detection signal, and invalidating the direction detection signal when these directions do not match, wherein, when the direction detection signal is valid, the track searching circuit performs the track search using the direction detection signal, and the tracking pull-in circuit performs the tracking control using the direction detection signal. Therefore, the reliability of the direction detection signal can be judged without adding a new circuit to the optical disk device, thereby suppressing an increase in the circuit scale.

According to a sixth aspect of the present invention, an optical disk device comprises a light beam spot for irradiating a track on an optical disk with laser light to receive reflected light of the laser light, an actuator for moving the light beam spot in a radial direction of the optical disk, a traverse for moving the light beam spot and the actuator in the radial direction of the optical disk, a tracking error detection circuit for detecting a tracking error signal on the basis of the reflected light of the laser light, a track cross signal detection circuit for detecting a track cross signal on the basis of the tracking error signal, an off-track signal detection circuit for detecting an off-track signal on the basis of the reflected light of the laser light, a direction detection circuit for detecting a direction detection signal which indicates the moving direction of the light beam spot with respect to the optical disk, on the basis of the track cross signal and the off-track signal, a track searching circuit performing track search for moving the light beam spot onto a desired track by driving the actuator and the traverse, a tracking pull-in circuit performing tracking control for making the light beam spot follow a desired track by driving the actuator, a track jump circuit for moving the light beam spot by one track on the optical disk, and a switching circuit for validating the direction detection signal when the direction in which the light beam spot is moved by the track jump circuit matches the moving direction of the light beam spot that is indicated by the direction detection signal, and invalidating the direction detection signal when these directions do not match, wherein, when the direction detection signal is valid, the track searching circuit performs the track search using the direction detection signal, and the tracking pull-in circuit performs the tracking control using the direction detection signal. Therefore, the reliability of the direction detection signal can be judged without adding a new circuit to the optical disk device, thereby suppressing an increase in the circuit scale.

According to a seventh aspect of the present invention, an optical disk device comprises a light beam spot for irradiating a track on an optical disk with laser light to receive reflected light of the laser light, an actuator for moving the light beam spot in a radial direction of the optical disk, a traverse for moving the light beam spot and the actuator in the radial direction of the optical disk, a tracking error detection circuit for detecting a tracking error signal on the basis of the reflected light of the laser light, a track cross signal detection circuit for detecting a track cross signal on the basis of the tracking error signal, an off-track signal detection circuit for detecting an off-track signal on the basis of the reflected light of the laser light, a direction detection circuit for detecting a direction detection signal which indicates the moving direction of the light beam spot with respect to the optical disk, on the basis of the track cross signal and the off-track signal, a track searching circuit performing track search for moving the light beam spot onto a desired track by driving the actuator and the traverse, a tracking pull-in circuit performing tracking control for making the light beam spot follow a desired track by driving the actuator, a phase detection circuit for detecting a phase difference between the track cross signal and the off-track signal, and a switching circuit for validating the direction detection signal when the phase difference between the track cross signal and the off-track signal is within a predetermined range of threshold values, and invalidating the direction detection signal when the phase difference is outside the predetermined range, wherein, when the direction detection signal is valid, the track searching circuit performs the track search using the direction detection signal, and the tracking pull-in circuit performs the tracking control using the direction detection signal. Therefore, the precision in the reliability judgment for the direction detection signal can be enhanced, and further, the judgment time can be reduced.

According to an eighth aspect of the present invention, in the optical disk device according to the seventh aspect, the switching circuit validates the direction detection signal when the phase difference is within a range from 80 deg to 100 deg. Therefore, the precision in the reliability judgment for the direction detection signal can be further enhanced.

According to a ninth aspect of the present invention, an optical disk device comprises a light beam spot for irradiating a track on an optical disk with laser light to receive reflected light of the laser light, an actuator for moving the light beam spot in a radial direction of the optical disk, a traverse for moving the light beam spot and the actuator in the radial direction of the optical disk, a tracking error detection circuit for detecting a tracking error signal on the basis of the reflected light of the laser light, a track cross signal detection circuit for detecting a track cross signal on the basis of the tracking error signal, an off-track signal detection circuit for detecting an off-track signal on the basis of the reflected light of the laser light, a direction detection circuit for detecting a direction detection signal which indicates the moving direction of the light beam spot with respect to the optical disk, on the basis of the track cross signal and the off-track signal, a track searching circuit performing track search for moving the light beam spot onto a desired track by driving the actuator and the traverse, a tracking pull-in circuit performing tracking control for making the light beam spot follow a desired track by driving the actuator, a logical operation circuit for operating an exclusive OR of the track cross signal and the off-track signal, a duty ratio measurement circuit for measuring a duty ratio of the output signal from the logical operation circuit, and a switching circuit for validating the direction detection signal when the duty ratio of the output signal from the logical operation circuit is within a predetermined range of threshold values, and invalidating the direction detection signal when the duty ratio is outside the predetermined range, wherein, when the direction detection signal is valid, the track searching circuit performs the track search using the direction detection signal, and the tracking pull-in circuit performs the tracking control using the direction detection signal. Therefore, the reliability of the direction detection signal can always be judged during the operation of the optical disk device, which eliminates the need for performing learning of the direction detection signal when the optical disk device is started up, resulting in a reduction in the initial start-up time.

According to a tenth aspect of the present invention, in the optical disk device according to the ninth aspect, the switching circuit validates the direction detection signal when the duty ratio is within a range from 40% to 60%. Therefore, the precision in the reliability judgment for the direction detection signal during the operation of the optical disk device can be further enhanced.

According to an eleventh aspect of the present invention, an optical disk device comprises a light beam spot for irradiating a track on an optical disk with laser light to receive reflected light of the laser light, an actuator for moving the light beam spot in a radial direction of the optical disk, a traverse for moving the light beam spot and the actuator in the radial direction of the optical disk, a tracking error detection circuit for detecting a tracking error signal on the basis of the reflected light of the laser light, a track cross signal detection circuit for detecting a track cross signal on the basis of the tracking error signal, an off-track signal detection circuit for detecting an off-track signal on the basis of the reflected light of the laser light, a phase changing circuit for changing the phase of the track cross signal or the off-track signal, a direction detection circuit for detecting a direction detection signal which indicates the moving direction of the light beam spot with respect to the optical disk, on the basis of the track cross signal and the off-track signal which are outputted from the phase changing circuit, a track searching circuit performing track search for moving the light beam spot onto a desired track by driving the actuator and the traverse, using the direction detection signal, and a tracking pull-in circuit performing tracking control for making the light beam spot follow a desired track by driving the actuator, using the direction detection signal. Therefore, a highly precise direction detection signal can be constantly obtained, thereby enhancing the precision of the track search or tracking pull-in control.

According to a twelfth aspect of the present invention, the optical disk device according to the eleventh aspect further includes a phase detection circuit for detecting a phase difference between the track cross signal and the off-track signal, and the phase changing circuit changes the phase of the track cross signal or the off-track signal according to the phase difference between the track cross signal and the off-track signal. Therefore, the precision of the direction detection signal can be enhanced even during the operation of the optical disk device, thereby eliminating the need for performing learning of the direction detection signal when the optical disk device is started up, resulting in a reduction in the initial start-up time.

According to a thirteenth aspect of the present invention, the optical disk device according to the eleventh aspect further includes a logical operation circuit for operating an exclusive OR of the track cross signal and the off-track signal, and the phase changing circuit changes the phase of the track cross signal or the off-track signal according to a duty ratio of an output signal from the logical operation circuit. Therefore, the precision of the direction detection signal can be enhanced even during the operation of the optical disk device, thereby eliminating the need for performing learning of the direction detection signal when the optical disk device is started up, resulting in a reduction in the initial start-up time.

According to a fourteenth aspect of the present invention, an optical disk device comprises a light beam spot for irradiating a track on an optical disk with laser light to receive reflected light of the laser light, an actuator for moving the light beam spot in a radial direction of the optical disk, a traverse for moving the light beam spot and the actuator in the radial direction of the optical disk, a tracking error detection circuit for detecting a tracking error signal on the basis of the reflected light of the laser light, a track cross signal detection circuit for detecting a track cross signal on the basis of the tracking error signal, an off-track signal detection circuit for detecting an off-track signal on the basis of the reflected light of the laser light, a direction detection circuit for detecting a direction detection signal which indicates the moving direction of the light beam spot with respect to the optical disk, on the basis of the track cross signal and the off-track signal, a track searching circuit performing track search for moving the light beam spot onto a desired track by driving the actuator and the traverse, using the direction detection signal, a tracking pull-in circuit performing tracking control for making the light beam spot follow a desired track by driving the actuator, using the direction detection signal, and a lens relative speed detection circuit for detecting a relative speed of the light beam spot to the optical disk, on the basis of any of the tracking error signal, the track cross signal, and the off-track signal, wherein the direction detection circuit holds the output of the direction detection signal when the relative speed of the light beam spot to the optical disk, which is detected by the lens relative speed detection circuit, is higher than a predetermined speed. Therefore, the precision in detecting the direction detection signal is enhanced, thereby avoiding false detection of the direction detection signal particularly when the moving speed of the lens is increased during seeking.

According to a fifteenth aspect of the present invention, an optical disk device comprises a light beam spot for irradiating a track on an optical disk with laser light to receive reflected light of the laser light, an actuator for moving the light beam spot in a radial direction of the optical disk, a traverse for moving the light beam spot and the actuator in the radial direction of the optical disk, a tracking error detection circuit for detecting a tracking error signal on the basis of the reflected light of the laser light, a track cross signal detection circuit for detecting a track cross signal on the basis of the tracking error signal, an off-track signal detection circuit for detecting an off-track signal on the basis of the reflected light of the laser light, a direction detection circuit for detecting a direction detection signal which indicates the moving direction of the light beam spot with respect to the optical disk, on the basis of the track cross signal and the off-track signal, a track searching circuit performing track search for moving the light beam spot onto a desired track by driving the actuator and the traverse, using the direction detection signal, a tracking pull-in circuit performing tracking control for making the light beam spot follow a desired track by driving the actuator, using the direction detection signal, and a defect detection circuit for detecting a defect on the optical disk, wherein the direction detection circuit holds the output of the direction detection signal when a defect on the optical disk is detected by the defect detection circuit. Therefore, the precision in detecting the direction detection signal is enhanced, thereby avoiding false detection of the direction detection signal particularly when the optical disk has a defect such as contamination or flaws.

### EFFECTS OF THE INVENTION

According to the present invention, the reliability of the direction detection signal is judged, and the direction detection signal is used for track search or tracking pull-in control only when the reliability is high. Therefore, even when the direction detection is not correctly performed due to a difference in reflected light quantity on the optical disk, a defect on the optical disk, a delay in the track cross speed during the search, or a delay in the detection circuit, it is possible to avoid that the track search control results in failure due to miscount of the number of track crosses, and that decelerating of the relative speed between the light beam spot and the track results in failure which leads to failure in the tracking pull-in control.

### BRIEF DESCRIPTION OF THE DRAWINGS

FIG. 1 is a schematic block diagram illustrating an optical disk device according to a first embodiment of the present invention.

FIG. 2 is a diagram illustrating waveforms of detected signals in the optical disk device according to the first embodiment.

FIG. 3 is a diagram illustrating waveforms of detected signals in the optical disk device according to the first embodiment.

FIG. 4 is a schematic block diagram illustrating an optical disk device according to a second embodiment of the present invention.

FIG. 5 is a diagram illustrating waveforms of detected signals in the optical disk device according to the second embodiment.

FIG. 6 is a diagram illustrating waveforms of detected signals in the optical disk device according to the second embodiment.

FIG. 7 is a schematic block diagram illustrating an optical disk device according to a third embodiment of the present invention.

FIG. 8 is a diagram illustrating waveforms of detected signals in the optical disk device according to the third embodiment.

FIG. 9 is a schematic block diagram illustrating an optical disk device according to a fourth embodiment of the present invention.

FIG. 10 is a diagram illustrating waveforms of detected signals in the optical disk device according to the fourth embodiment.

FIG. 11 is a schematic block diagram illustrating an optical disk device according to a fifth embodiment of the present invention.

FIG. 12 is a diagram illustrating waveforms of detected signals in the optical disk device according to the fifth embodiment.

FIG. 13 is a schematic block diagram illustrating an optical disk device according to a sixth embodiment of the present invention.

FIG. 14 is a diagram illustrating waveforms of detected signals in the optical disk device according to the sixth embodiment.

FIG. 15 is a schematic block diagram illustrating an optical disk device according to a seventh embodiment of the present invention.

FIG. 16 is a schematic block diagram illustrating an optical disk device according to an eighth embodiment of the present invention.

FIG. 17 is a diagram illustrating waveforms of detected signals in the optical disk device according to the eighth embodiment.

FIG. 18 is a schematic block diagram illustrating an optical disk device according to a ninth embodiment of the present invention.

FIG. 19 is a diagram illustrating waveforms of detected signals in the optical disk device according to the ninth embodiment.

### DETAILED DESCRIPTION OF THE PREFERRED EMBODIMENTS

Hereinafter, optical disk devices according to the embodiments of the present invention will be described with reference to the drawings.

### Embodiment 1

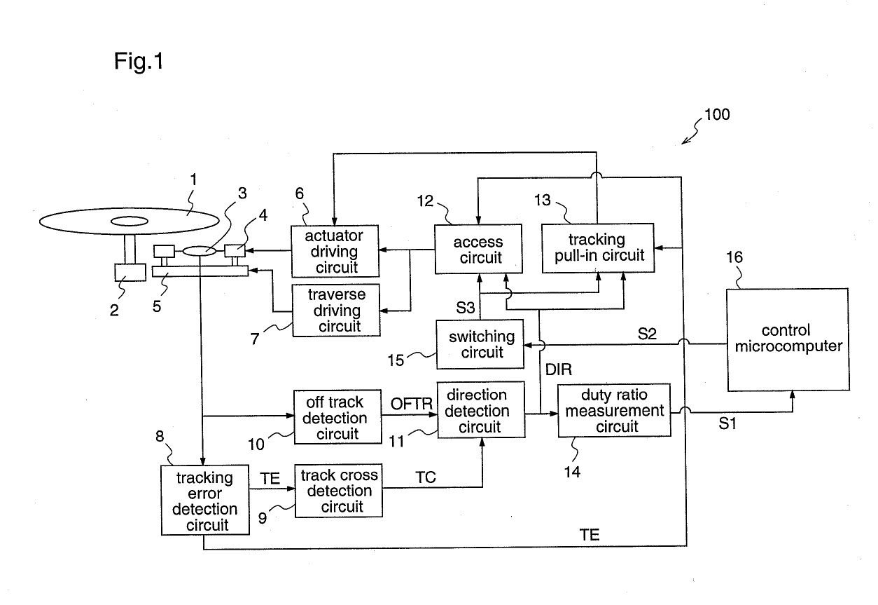

FIG. 1 is a block diagram illustrating the construction of an optical disk device 100 according to a first embodiment of the present invention.

The optical disk device 100 according to the first embodiment includes a disk motor 2 for rotating an optical disk 1, a light beam spot 3 for irradiating the optical disk 1 with laser light to receive reflected light of the laser light, an actuator 4 for moving the light beam spot 3 in the radial direction of the optical disk 1, a traverse 5 for moving the light beam spot 3 and the actuator 4 in the radial direction of the optical disk 1, an actuator driving circuit 6 form driving the actuator 4, and a traverse driving circuit 7 for driving the traverse 5.

Further, in FIG. 1, reference numeral 8 denotes a tracking error detection circuit. Since the optical disk 1 is formed of a plastic material, it has a warpage or a wave due to a thermal strain or the like during fabrication, thereby causing a vertical vibration at the surface of the optical disc 1. Further, the optical disk 1 has a surface fluctuation and a track vibration caused by a deflection or the like due to its own weight. So, the tracking error detection circuit 8 detects a deviation of the light beam spot 3 from a proper position on the track, i.e., a tracking error, which is caused by the surface fluctuation or track vibration. Particularly, the tracking error detection circuit 8 generates a tracking error signal TE whose amplitude varies vertically around a reference voltage every time the light beam spot 3 crosses the track on the optical disk 1.

Reference numeral 9 denotes a track cross detection circuit for detecting a track cross signal TC which is obtained by binarizing the tracking error signal TE outputted from the tracking error detection circuit 8.

Reference numeral 10 denotes an off-track detection circuit for detecting an off-track signal OFTR indicating whether the light beam spot 3 is positioned on the track or between the tracks on the optical disk 1. This off-track signal OFTR can be obtained by binarizing a signal which has a minimum level when the light beam spot 3 is positioned directly above the track, and a maximum level when the light beam spot 3 is positioned between the tracks.

Reference numeral 11 denotes a direction detection circuit which compares the track cross signal TC with the off-track signal to output a direction detection signal DIR indicating the direction in which the optical beam spot 3 moves with respect to the track on the optical disk 1. In this first embodiment, the direction detection circuit 11 sets the direction detection signal DIR to H level when the track cross signal TC is at H level at the falling edge of the off-track signal OFTR, and sets the direction detection signal DIR to L level when the track cross signal TC is at H level at the rising edge of the off-track signal OFTR.

Reference numeral 12 denotes an access circuit which moves the actuator 4 and the traverse 5 in the radial direction of the optical disk 1 by using the actuator driving circuit 6 and the traverse driving circuit 7, thereby to move the light beam spot 3 onto a desired track on the optical disk 1. This access circuit 12 counts the number of tracks the optical beam spot 3 crosses, by detecting the edges of the tracking error signal TE or the track cross signal TC, and brings the light beam spot 3 close to the target track.

In this case, the tracking error signal TE or the track cross signal TC is counted as one track regardless of which direction the light beam spot 3 moves with respect to the track on the optical disk 1. Therefore, when the access circuit 12 receives a signal indicating that the direction detection signal DIR is valid from a switching circuit 15 to be described later, the access circuit 12 performs counting, using the direction detection signal DIR, as +1 track when the light beam spot 3 moves in the target direction, and as −1 track when the light beam spot 3 moves in the reverse direction, thereby accurately counting the tracks on which the light beam spot 3 actually crosses.

Further, the access circuit 12 has a function of outputting an acceleration pulse and a deceleration pulse to keep the speed of the light beam spot 3 constant during access to the optical disk 1. Also in this case, since it is unknown in which direction the light beam spot 3 moves with respect to the track on the optical disc 1, there is a possibility that the access circuit 12 might output a reverse pulse. Accordingly, when the direction detection signal DIR is valid, the access circuit 12 outputs an acceleration signal and a deceleration signal on the basis of this direction detection signal DIR.

Reference numeral 13 denotes a tracking pull-in circuit which detects a deviation of the light beam spot 3 from the proper position on the track, which deviation is caused by a surface fluctuation or a track vibration of the optical disk 1, on the basis of the tracking error signal TE, and makes the light beam spot 3 follow a desired track on the optical disk 1 by using the actuator driving circuit 5 and the traverse driving circuit 7. While the tracking pull-in circuit 13 starts tracking pull-in at the moment when the light beam spot 3 approaches the track on the optical disk 1, there is a possibility that the tracking pull-in circuit 13 fails in the tracking pull-in if the relative speed between the light beam spot 3 and the track is high. Therefore, in order to decrease the relative speed between the light beam spot 3 and the track, a deceleration pulse is outputted to the light beam spot 3. In this case, since it is unknown in which direction the light beam spot 3 moves with respect to the track on the optical disk 1, there is a possibility that a reverse pulse might be outputted by mistake. Accordingly, when the direction detection signal DIR is valid, the tracking pull-in circuit 13 refers to the direction detection signal DIR with regard to the direction of outputting the deceleration pulse.

Reference numeral 14 denotes a duty ratio measurement circuit for measuring the ratio of High/Low zones of the direction detection signal DIR which is a binarized signal.

Reference numeral 15 denotes a switching circuit which outputs a control signal S3 indicating whether the direction detection signal DIR is to be used as the basis or not when the access circuit 12 counts the number of tracks or when the access circuit 12 or the tracking pull-in circuit 13 performs control of outputting an acceleration pulse or a deceleration pulse, thereby switching the validity of the direction detection signal DIR.

Reference numeral 16 denotes a control microcomputer for judging the validity of the direction detection signal DIR on the basis of an output signal S1 of the duty ratio measurement circuit 14, thereby operating the switching circuit 15.

Next, the operation of the optical disk device will be described.

When a light-receiving signal from the light beam spot 3 is input to the tracking error detection circuit 8 and the off-track detection circuit 10 under the state where tracking control of the optical disc device 100 is off and the lens is fixed, a tracking error signal TE is detected by the tracking error detection circuit 8, and outputted to the track cross detection circuit 9 and the tracking pull-in circuit 13. Further, an off-track signal OFTR is detected by the off-track detection circuit 10, and outputted to the direction detection circuit 11. In the track cross detection circuit 9, a track cross signal TC is detected on the basis of the tracking error signal TE, and outputted to the direction detection circuit 11.

In the direction detection circuit 11, a direction detection signal DIR is detected on the basis of the track cross signal TC and the off-track signal OFTR, and outputted to the access circuit 12, the tracking pull-in circuit 13, and the duty ratio measurement circuit 14.

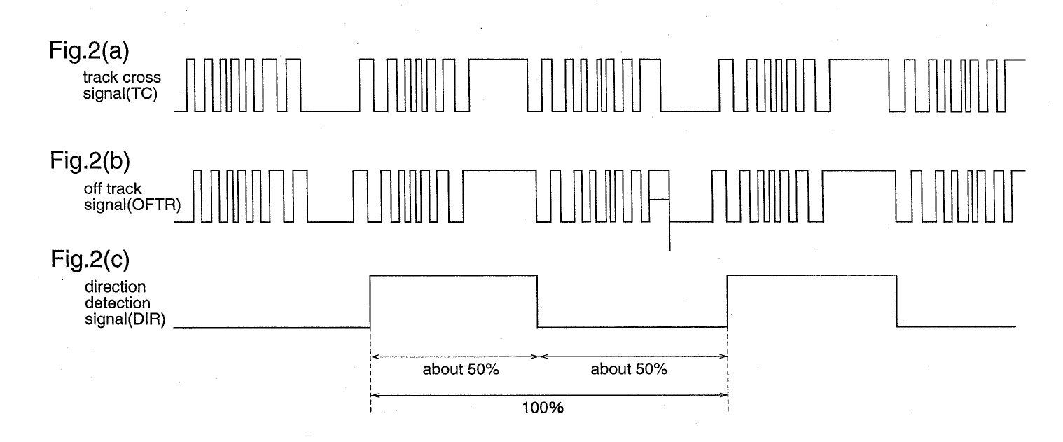

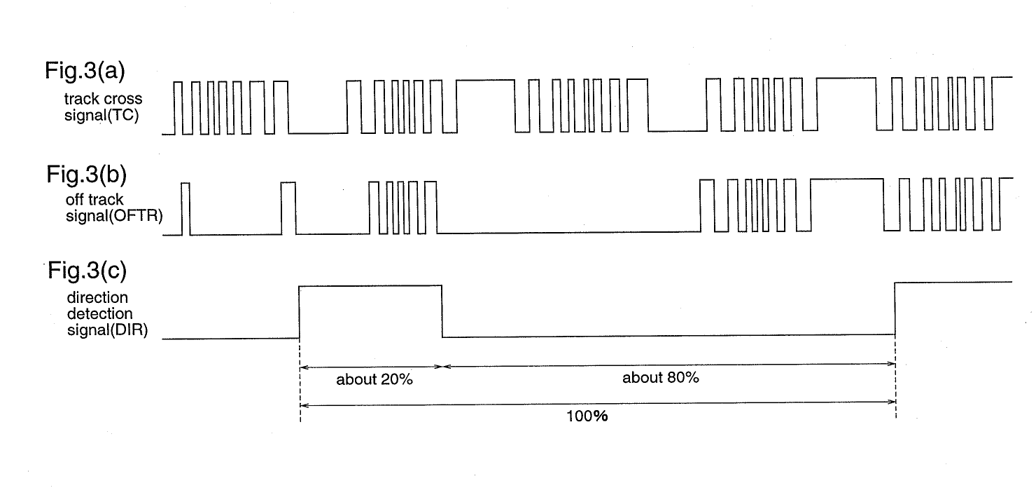

In the duty ratio measurement circuit 14, the duty ratio of the direction detection signal DIR is measured, and the result is outputted to the control microcomputer 16. Then, the reliability of the direction detection signal DIR is judged by the control microcomputer 16 on the basis of the measurement result S1 of the duty ratio of the direction detection signal DIR. Hereinafter, the method of judging the reliability of the direction detection signal DIR by the control microcomputer 16 will be described with reference to FIGS. 2 and 3.

FIGS. 2(a) and 3(a) show the track cross signal TC, 2(b) and 3(b) show the off-track signal OFTR, and 2(c) and 3(c) show the direction detection signal DIR, respectively.

When the track cross signal TC, the off-track signal OFTR, and the direction detection signal DIR are correctly outputted under the state where tracking control is off and the lens is fixed, the periods during which the lens crosses the disk toward the inner circumference and the outer circumference are approximately equal to each other due to decentering of the disk, and the duty ratio of the direction detection signal DIR has a waveform close to 50% as shown in FIG. 2. On the other hand, when the off-track signal OFTR is not correctly outputted, the duty ratio of the direction detection signal DIR becomes inconstant as shown in FIG. 3.

When the duty ratio of the direction detection signal DIR is close to 50%, for example, when it is in a range from 40% to 60%, the control microcomputer 16 judges that the reliability of the direction detection signal DIR is high, and outputs a control signal S2 indicating the judgment result to the switching circuit 15. When the duty ratio of the direction detection signal DIR is outside the above-mentioned range, it is judged that the reliability of the direction detection signal DIR is low, and a control signal S2 indicating the judgment result is output to the switching circuit 15.

When it is judged that the reliability of the direction detection signal DIR is high, a switching signal S3 indicating that the direction detection signal DIR is valid is output from the switching circuit 15 to the access circuit 12 and the tracking pull-in circuit 13, and consequently, the access circuit 12 performs counting of tracks and outputting of an acceleration pulse or a deceleration pulse on the basis of the direction detection signal DIR, thereby performing access control to the optical disk 1. Further, the tracking pull-in circuit 13 performs outputting of an acceleration pulse or a deceleration pulse on the basis of the direction detection signal DIR, thereby performing tracking pull-in control.

On the other hand, when it is judged that the reliability of the direction detection signal DIR is low, a control signal S3 indicating that the direction detection signal DIR is invalid is output from the switching circuit 15 to the access circuit 12 and the tracking pull-in circuit 13, and consequently, the access circuit 12 and the tracking pull-in circuit 13 perform access to the optical disk 1 and tracking pull-in control, respectively, without using the direction detection signal DIR.

As described above, according to the optical disk device of the first embodiment, the reliability of the light beam spot moving direction indicated by the direction detection signal DIR is judged on the basis of the duty ratio of the direction detection signal DIR, and only when it is judged that the reliability is high, the direction detection signal is used for the track search and the tracking pull-in control. Therefore, it is possible to realize the track search and the tracking pull-in with stability.

### Embodiment 2

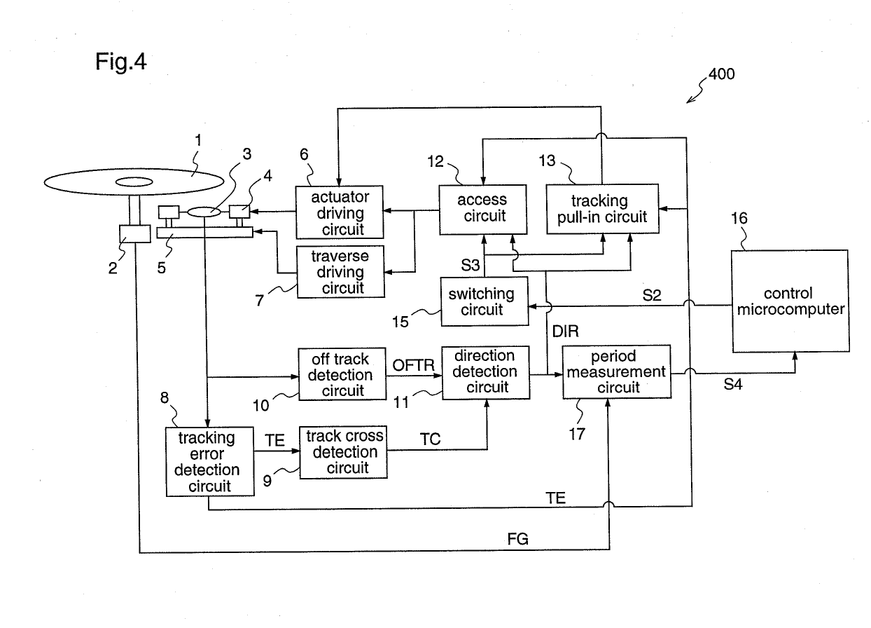

FIG. 4 is a block diagram illustrating the construction of an optical disk device 400 according to a second embodiment of the present invention.

In FIG. 4, reference numeral 17 denotes a period measurement circuit for measuring the period of the direction detection signal DIR which is a binarized signal, on the basis of a FG signal outputted from the disk motor 2.

Further, the control microcomputer 16 according to the second embodiment judges the validity of the direction detection signal DIR on the basis of a measurement result S4 outputted from the period measurement circuit 17, and operates the switching circuit 15. In FIG. 4, the same constituents as those of the first embodiment are given the same reference numerals to omit the description thereof.

Next, the operation will be described.

When a light-receiving signal from the light beam spot 3 is input to the tracking error detection circuit 8 and the off-track detection circuit 10 under the state where tracking control is off and the lens is fixed, a tracking error signal TE is detected by the tracking error detection circuit 8, and output to the track cross detection circuit 9 and the tracking pull-in circuit 13. Further, an off-track signal OFTR is detected by the off-track detection circuit 10 on the basis of the light-receiving signal from the light beam spot 3, and output to the direction detection circuit 11. In the track cross detection circuit 9, a track cross signal TC is detected on the basis of the tracking error signal TE, and output to the direction detection circuit 11. Then, in the direction detection circuit 11, a direction detection signal DIR is detected on the basis of the track cross signal TC and the off-track signal OFTR, and output to the access circuit 12, the tracking pull-in circuit 13, and the period measurement circuit 17.

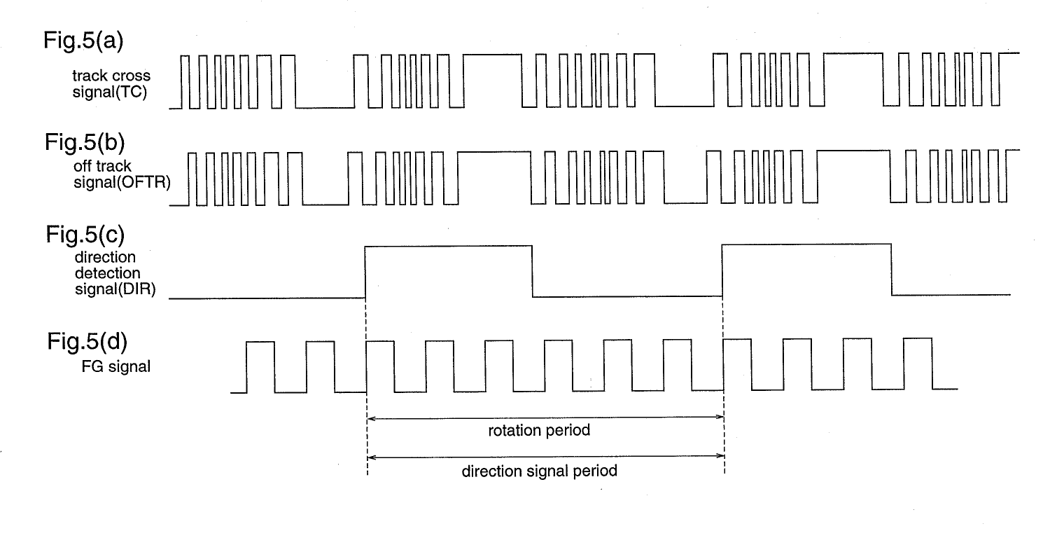

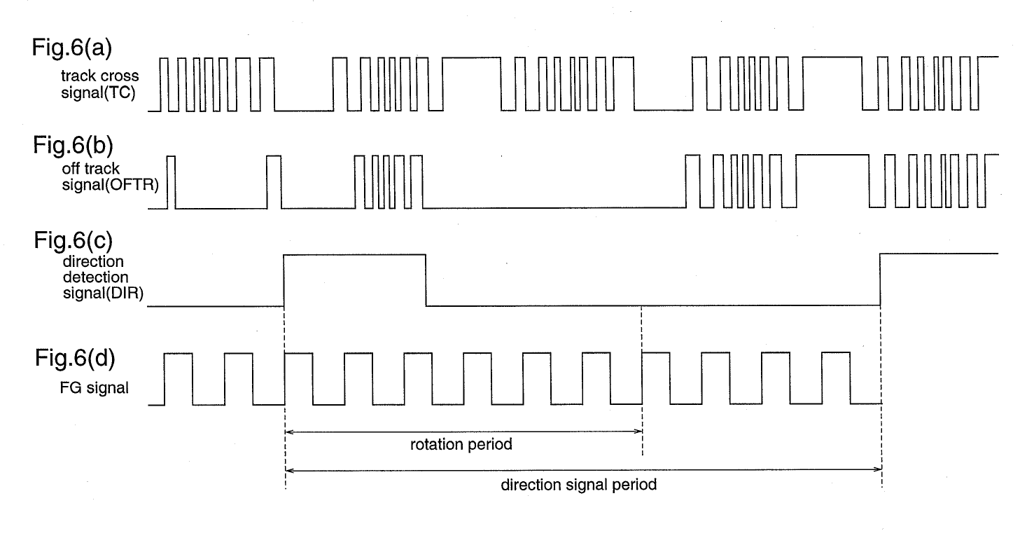

In the period measurement circuit 17, the periods of the High/Low zones of the direction detection signal DIR are measured based on the FG signal, and the measurement result S4 is output to the control microcomputer 16. Then, the control microcomputer 16 judges the reliability of the direction detection signal DIR on the basis of the measurement result S4. Hereinafter, a description will be given of the method of judging the reliability of the direction detection signal DIR by the control microcomputer 16 of the second embodiment, with reference to FIGS. 5 and 6.

FIGS. 5(a) and 6(a) show the track cross signal TC, 5(b) and 6(b) show the off-track signal OFTR, 5(c) and 6(c) show the direction detection signal DIR, and 5(d) and 6(d) show the FG signal, respectively. In this second embodiment, as for the FG signal, six pulses are output for one round of the disk.

In the optical disk device 400, when the track cross signal TC and the off-track signal OFTR are correctly outputted, the period during which the lens crosses the disk from the inner circumference side to the outer circumference side due to decentering of the disk becomes approximately equal to the period of the direction detection signal DIR, i.e., the rotation period of the disk, as shown in FIG. 5. On the other hand, when the off-track signal OFTR is not correctly outputted, the period of the direction detection signal DIR and the rotation period are unstable as shown in FIG. 6.

When the period of the direction detection signal DIR while the tracking control is off is within a range from 90% to 100% of the rotation frequency, the control microcomputer 16 judges that the reliability of the direction detection signal DIR is high, and outputs the judgement result S2 to the switching circuit 15. When the period of the direction detection signal DIR is outside the above-mentioned range, it is judged that the reliability of the direction detection signal DIR is low, and the judgement result S2 is output to the switching circuit 15.

When it is judged that the reliability of the direction detection signal DIR is high, a switching signal S3 indicating that the direction detection signal DIR is valid is output from the switching circuit 15 to the access circuit 12 and the tracking pull-in circuit 13, and consequently, the access circuit 12 performs counting of tracks and outputting of an acceleration pulse or a deceleration pulse on the basis of the direction detection signal DIR, thereby performing access control to the optical disk 1. Further, the tracking pull-in circuit 13 performs outputting of an acceleration pulse or a deceleration pulse on the basis of the direction detection signal DIR, thereby performing tracking pull-in control.

On the other hand, when it is judged that the reliability of the direction detection signal DIR is low, a control signal S3 indicating that the direction detection signal DIR is invalid is output from the switching circuit 15 to the access circuit 12 and the tracking pull-in circuit 13, and consequently, the access circuit 12 and the tracking pull-in circuit 13 perform access to the optical disk 1 and tracking pull-in control, respectively, without using the direction detection signal DIR.

As described above, according to the optical disk device of the second embodiment, the reliability of the light beam spot moving direction indicated by the direction detection signal DIR is judged on the basis of the period of the direction detection signal DIR, and only when the reliability is high, the direction detection signal is used for the track search and the tracking pull-in control. Therefore, it is possible to realize more safe and stable track search and tracking pull-in.

### Embodiment 3

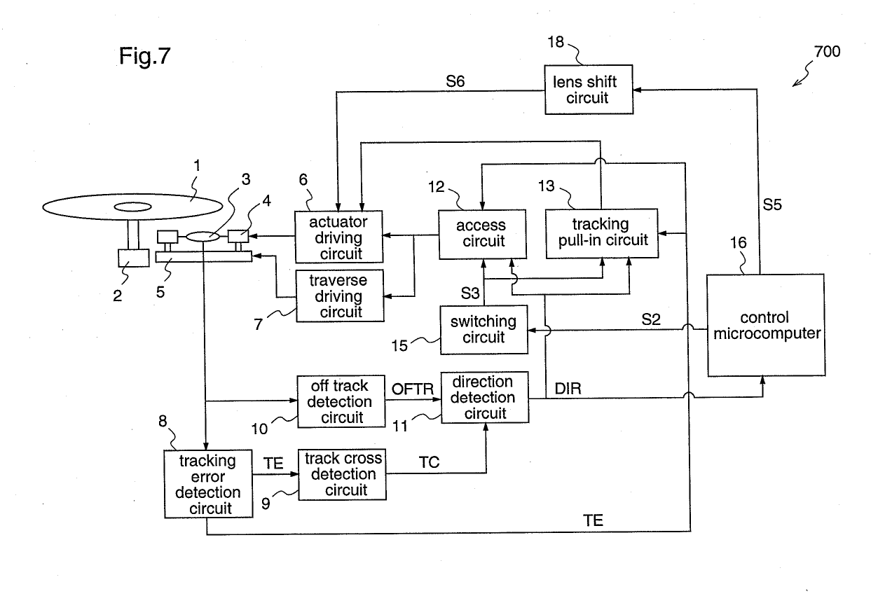

FIG. 7 is a block diagram illustrating the construction of an optical disk device 700 according to a third embodiment of the present invention.

In FIG. 7, reference numeral 18 denotes a lens shift circuit which receives a control signal S5 outputted from the control microcomputer 16, and outputs a tracking drive signal S6 to the actuator driving circuit 6 to drive the actuator 4, thereby moving the light beam spot 3 in the radial direction of the optical disk 1. The tracking drive signal S6 is a drive output which is given to the actuator driving circuit 6 from the lens shift circuit 18, and thereby the light beam spot 3 is moved in the radial direction of the optical disk 1.

Further, the control microcomputer 16 according to this third embodiment outputs a control signal S5 instructing the lens shift circuit 18 to perform a lens shift toward a specific direction, and judges the reliability of the direction detection signal DIR on the basis of the direction of the lens shift that is instructed to the lens shift circuit 18 and the relative moving direction of the lens that is indicated by the direction detection signal DIR, thereby to operate the switching circuit 15. The other constituents are identical to those of the first embodiment.

Next, the operation will be described.

When a light-receiving signal from the light beam spot 3 is input to the tracking error detection circuit 8 and the off-track detection circuit 10 under the state where tracking control is off and the lens is fixed, a tracking error signal TE is detected by the tracking error detection circuit 8, and output to the track cross detection circuit 9 and the tracking pull-in circuit 13. Further, an off-track signal OFTR is detected by the off-track detection circuit 10 on the basis of the light-receiving signal from the light beam spot 3, and output to the direction detection circuit 11. In the track cross detection circuit 9, a track cross signal TC is detected on the basis of the tracking error signal TE, and output to the direction detection circuit 11. Then, in the direction detection circuit 11, a direction detection signal DIR is detected on the basis of the track cross signal TC and the off-track signal OFTR, and output to the access circuit 12, the tracking pull-in circuit 13, and the control microcomputer 16.

The control microcomputer 16 outputs a control signal S5 instructing the lens shift circuit 18 to shift the light beam spot 3 from the inner circumference toward the outer circumference, and thereby a tracking drive signal S6 is output from the lens shift circuit 18, and the light beam spot 3 is shifted from the inner circumference toward the outer circumference. Then, the control microcomputer 16 judges the reliability of the direction detection signal DIR on the basis of the lens moving direction that is indicated by the direction detection signal DIR during the lens shift.

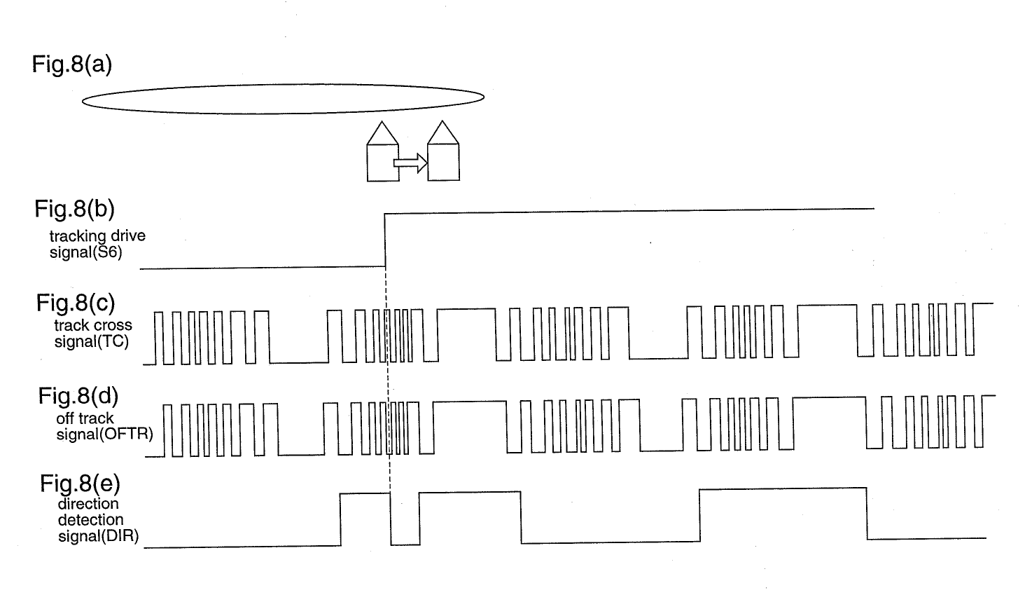

FIG. 8(a) shows the moving direction of the light beam spot 3, 8(b) shows the tracking drive signal S6, 8(c) shows the track cross signal TC, 8(d) shows the off-track signal OFTR, and 8(e) shows the direction detection signal DIR, in the case where the light beam spot 3 is moved toward the outer circumference of the optical disk 1 while the tracking control is off and the lens is fixed.

If the direction detection signal DIR is similarly changed to the direction toward the outer circumference at the timing when the tracking drive signal S6 is applied to the actuator driving circuit 6 and the light beam spot 3 moves toward the outer circumference of the optical disk, the control microcomputer 16 judges that the reliability of the direction detection signal DIR is high, and this judgment is informed to the switching circuit 15. Conversely, when the direction detection signal DIR is changed to the direction toward the inner circumference at the timing when the light beam spot 3 moves toward the outer circumference of the optical disk, it is judged that the reliability of the direction detection signal DIR is low, and this judgment is informed to the switching circuit 15. The reliability of the direction detection signal DIR can be further increased by repeating the above-described reliability judgement several times.

When the reliability of the direction detection signal DIR is high, a switching signal S3 indicating that the direction detection signal DIR is valid is output from the switching circuit 15 to the access circuit 12 and the tracking pull-in circuit 13, and consequently, the access circuit 12 performs counting of tracks and outputting of an acceleration pulse or a deceleration pulse on the basis of the direction detection signal DIR, thereby performing access control to the optical disk 1. Further, the tracking pull-in circuit 13 performs outputting of an acceleration pulse or a deceleration pulse on the basis of the direction detection signal DIR, thereby performing tracking pull-in control.

On the other hand, when the reliability of the direction detection signal DIR is low, a control signal S3 indicating that the direction detection signal DIR is invalid is output from the switching circuit 15 to the access circuit 12 and the tracking pull-in circuit 13, and consequently, the access circuit 12 and the tracking pull-in circuit 13 perform access to the optical disk 1 and tracking pull-in control, respectively, without using the direction detection signal DIR.

As described above, according to the optical disk device of the third embodiment, the reliability of the light beam spot moving direction indicated by the direction detection signal DIR is judged on the basis of the lens shift direction and the lens moving direction that is indicated by the direction detection signal during the lens shift, and only when the reliability is high, the direction detection signal is used for the track search and the tracking pull-in control. Therefore, it is possible to realize safe and stable track search and tracking pull-in.

In the optical disk device according to the third embodiment, since it is not necessary to add a special circuit for judging the reliability of the direction detection signal, an increase in the circuit scale can be suppressed.

### Embodiment 4

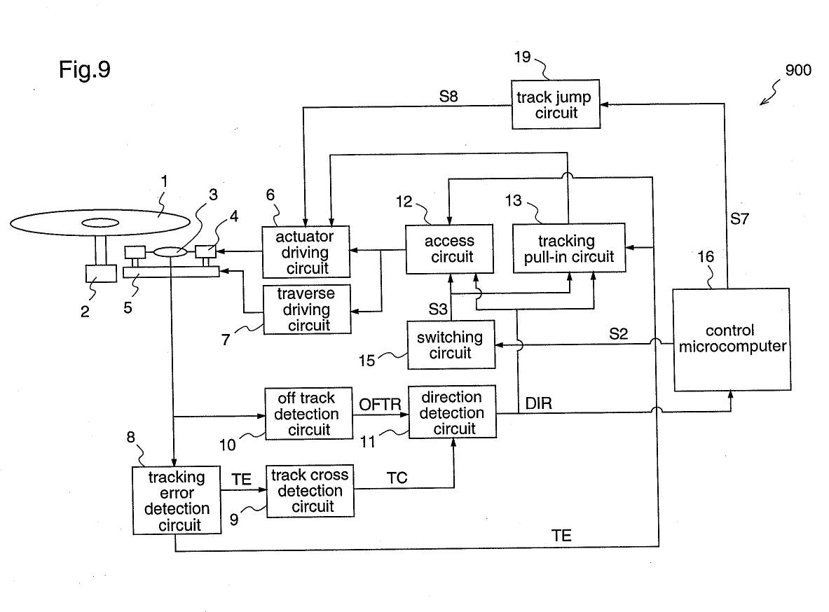

FIG. 9 is a block diagram illustrating the construction of an optical disk device 900 according to a fourth embodiment of the present invention.

In FIG. 9, reference numeral 19 denotes a track jump circuit which receives a control signal S7 outputted from the control microcomputer 16, and outputs a tracking drive signal S8 to the actuator driving circuit 6 to move the light beam spot 3 by one track on the optical disk. The tracking drive signal S8 is a driving output that is given to the actuator driving circuit 6 from the lens shift circuit 18, and the light beam spot 3 is moved by one track in the radial direction of the optical disk by pulse-wise giving this driving output to the light beam spot 3.

Further, the control microcomputer 16 according to this fourth embodiment outputs a control signal S7 which instructs the track jump circuit 19 to perform a track jump in a predetermined direction, and judges the reliability of the direction detection signal DIR on the basis of the direction of the instructed track jump and the relative moving direction of the lens indicated by the direction detection signal DIR, thereby operating the switching circuit 15. Other constituents are identical to those of the first embodiment.

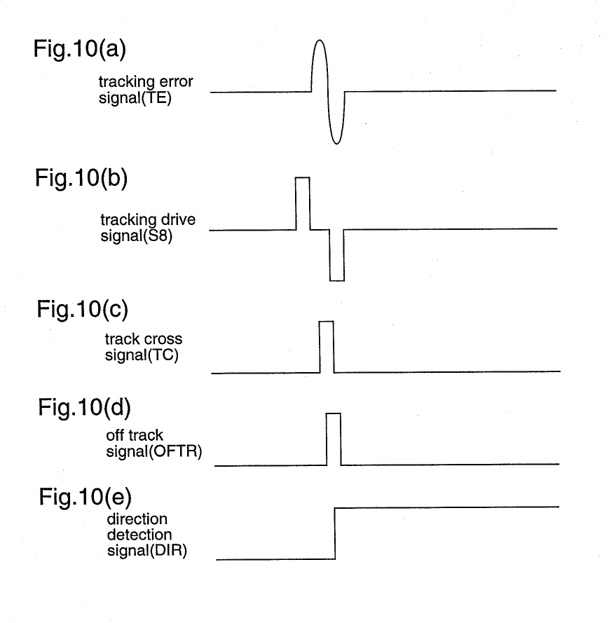

Next, the operation of the optical disk device 900 constituted as described above will be described with reference to FIG. 10.

FIG. 10(a) shows the tracking error TE, 10(b) shows the tracking drive signal S8, 10(c) shows the track cross signal TC, 10(d) shows the off-track signal OFTR, and 10(e) shows the direction detection signal DIR.

Initially, when a control signal S7 instructing the track jump circuit 19 to move the light beam spot 3 by one track toward the outer circumference is output from the control microcomputer 16 under the state where the tracking control of the optical disk device 900 is on, the track jump circuit 19 outputs a tracking drive signal S8, and thereby the light beam spot 3 moves by one track toward the outer circumference of the optical disk 1.

Then, with a change in the tracking error signal TE, a rectangle track cross signal TC is detected by the track cross detection circuit 9, and output to the direction detection circuit 11. Further, a rectangle off-track signal OFTR is detected by the off-track detection circuit 10, and output to the direction detection circuit 11. Then, in the direction detection circuit 11, a direction detection signal DIR is detected on the basis of the track cross signal TC and the off-track signal OFTR, and the direction detection signal DIR is output to the control microcomputer 16.

When the direction detection signal DIR is similarly changed to the direction toward the outer circumference at the timing when the light beam spot 3 moves by one track on the optical disk 1 toward the outer circumference, the control microcomputer 16 judges that the reliability of the direction detection signal DIR is high, and outputs the judgment result S2 to the switching circuit 15. Conversely, when the direction detection signal DIR is changed to the direction toward the inner circumference, it is judged that the reliability of the direction detection signal DIR is low, and the judgment result S2 is output to the switching circuit 15. The reliability can be further enhanced by repeating the above-described reliability judgment several times.

When it is judged that the reliability of the direction detection signal DIR is high, a switching signal S3 indicating that the direction detection signal DIR is valid is output from the switching circuit 15 to the access circuit 12 and the tracking pull-in circuit 13, and consequently, the access circuit 12 performs counting of tracks and outputting of an acceleration pulse or a deceleration pulse on the basis of the direction detection signal DIR, thereby performing access control to the optical disk 1. Further, the tracking pull-in circuit 13 performs outputting of an acceleration pulse or a deceleration pulse on the basis of the direction detection signal DIR, thereby performing tracking pull-in control.

On the other hand, when it is judged that the reliability of the direction detection signal DIR is low, a control signal S3 indicating that the direction detection signal DIR is invalid is output from the switching circuit 15 to the access circuit 12 and the tracking pull-in circuit 13, and consequently, the access circuit 12 and the tracking pull-in circuit 13 perform access to the optical disk 1 and tracking pull-in control, respectively, without using the direction detection signal DIR.

As described above, according to the optical disk device of the fourth embodiment, the reliability of the light beam spot moving direction indicated by the direction detection signal DIR is judged on the basis of the track jumping direction and the optical beam spot moving direction that is indicated by the direction detection signal during the track jump, and only when the reliability is high, the direction detection signal is used for the track search and the tracking pull-in control. Therefore, it is possible to realize safe and stable track search and tracking pull-in.

According to the optical disk device of the fourth embodiment, since it is not necessary to add a special circuit for judging the reliability of the direction detection signal, an increase in the circuit scale can be suppressed.

### Embodiment 5

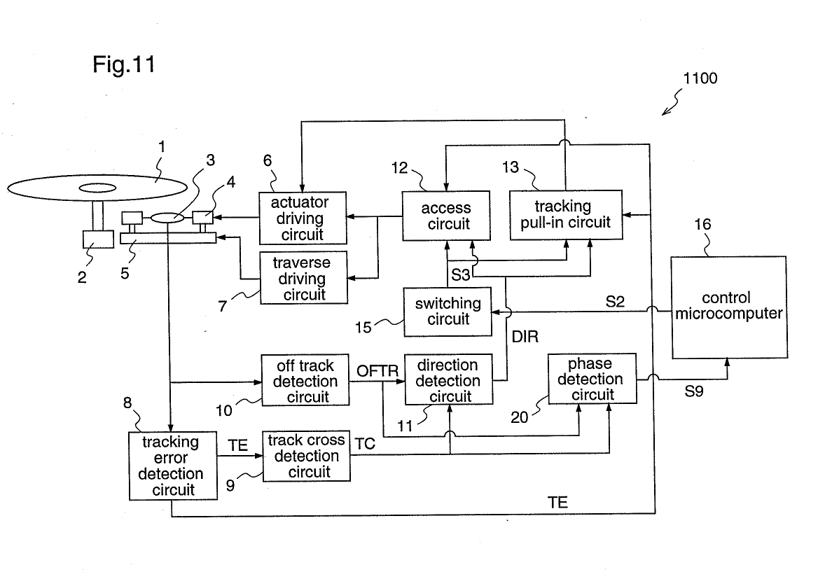

FIG. 11 is a block diagram illustrating the construction of an optical disk device 1100 according to a fifth embodiment of the present invention.

In FIG. 11, reference numeral 20 denotes a phase detection circuit for detecting a phase difference between the track cross signal TC and the off-track signal OFTR.

Further, the control microcomputer 16 according to the fifth embodiment judges the reliability of the direction detection signal DIR on the basis of a phase difference detection signal S9 outputted from the phase detection circuit 20. The other constituents are identical to those of the first embodiment described above.

Next, the operation will be described.

Initially, as described in the first embodiment, under the state where the tracking control is off and the lens is fixed, the track cross detection circuit 9 detects a track cross signal TC on the basis of a tracking error signal TE, and the off-track detection circuit 10 detects an off-track signal OFTR. These track cross signal TC and off-track signal OFTR are output to the direction detection circuit 11 and the phase detection circuit 20. The direction detection circuit 11 detects a direction detection signal DIR on the basis of the track cross signal TC and the off-track signal OFTR, and outputs the signal DIR to the access circuit 12 and the tracking pull-in circuit 13.

The phase detection circuit 20 measures a phase difference between the track cross signal TC and the off-track signal OFTR, and outputs a phase difference detection signal S9 indicating the measurement result to the control microcomputer 16.

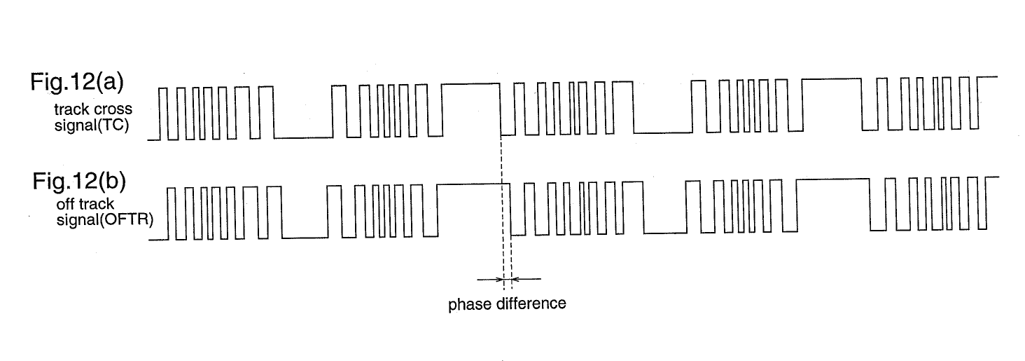

The control microcomputer 16 judges the reliability of the direction detection signal DIR on the basis of the phase difference between the track cross signal TC and the off-track signal OFTR. FIGS. 12(a) and 12(b) show the track cross signal TC, and the off-track signal OFTR, respectively.

In the optical disk device 1100, when the track cross signal TC and the off-track signal OFTR are correctly outputted, the phase difference between the track cross signal TC and the off-track signal OFTR is about 90 deg.

When the phase difference between the track cross signal TC and the off-track signal OFTR is within a range from 80 deg to 100 deg, the control microcomputer 16 judges that the reliability of the direction detection signal DIR is high, and when the phase difference is outside the above-mentioned range, the control microcomputer 16 judges that the reliability of the direction detection signal DIR is low, and then the judgment result S2 is output to the switching circuit 15.

When it is judged that the reliability of the direction detection signal DIR is high, a switching signal S3 indicating that the direction detection signal DIR is valid is output from the switching circuit 15 to the access circuit 12 and the tracking pull-in circuit 13, and consequently, the access circuit 12 performs counting of tracks and outputting of an acceleration pulse or a deceleration pulse on the basis of the direction detection signal DIR, thereby performing access control to the optical disk 1. Further, the tracking pull-in circuit 13 performs outputting of an acceleration pulse or a deceleration pulse on the basis of the direction detection signal DIR, thereby performing tracking pull-in control.

On the other hand, when it is judged that the reliability of the direction detection signal DIR is low, a control signal S3 indicating that the direction detection signal DIR is invalid is output from the switching circuit 15 to the access circuit 12 and the tracking pull-in circuit 13, and consequently, the access circuit 12 and the tracking pull-in circuit 13 perform access to the optical disk 1 and tracking pull-in control, respectively, without using the direction detection signal DIR.

As described above, according to the optical disk device of the fifth embodiment, the reliability of the light beam spot moving direction that is indicated by the direction detection signal is judged on the basis of the phase difference between the track cross signal TC and the off-track signal OFTR, and the direction detection signal is used for track search and tracking pull-in control only when the reliability is high. Therefore, it is possible to realize safe and stable track search and tracking pull-in.

In the optical disk device according to the fifth embodiment, since the reliability of the direction detection signal is judged on the basis of the phase difference between the track cross signal TC and the off-track signal OFTR, the judgment can be performed in short time.

### Embodiment 6

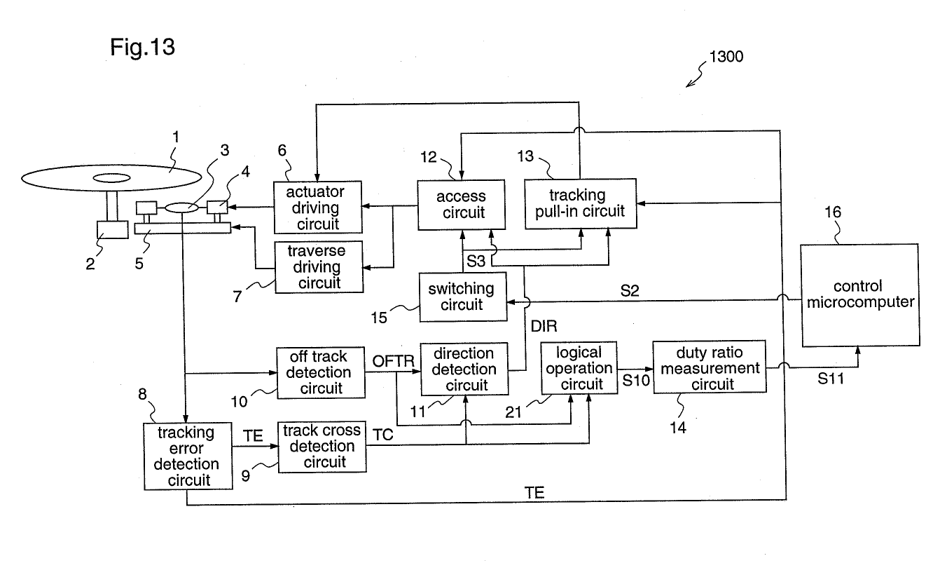

FIG. 13 is a block diagram illustrating the construction of an optical disk device 1300 according to a sixth embodiment of the present invention.

In FIG. 13, reference numeral 21 denotes a logical operation circuit for calculating an exclusive OR between the track cross signal TC and the off-track signal OFTR to generate a logical operation signal S10. Further, reference numeral 14 denotes a duty ratio measurement circuit for measuring the ratio of High/Low zones of the logical operation signal S10.

Further, the control microcomputer 16 according to this sixth embodiment judges the reliability of the direction detection signal DIR on the basis of the measurement result S11 of the duty ratio of the logical operation signal S10. Other constituents are identical to those of the above-described first embodiment.

Next, the operation will be described.

Initially, under the state where the tracking control is off and the lens is fixed, the track cross detection circuit 9 detects a track cross signal TC on the basis of a tracking error signal TE, and the off-track detection circuit 10 detects an off-track signal OFTR. These track cross signal TC and off-track signal OFTR are output to the direction detection circuit 11 and the logical operation circuit 21. The direction detection circuit 11 detects a direction detection signal DIR on the basis of the track cross signal TC and the off-track signal OFTR, and outputs the signal DIR to the access circuit 12 and the tracking pull-in circuit 13.

The logical operation circuit 21 operates an exclusive OR between the track cross signal TC and the off-track signal OFTR, and outputs a logical operation signal S10 to the duty ratio measurement circuit 14. Then, the duty ratio measurement circuit 14 measures the duty ratio of the logical operation signal S10, and outputs the measurement result S11 to the control microcomputer 16.

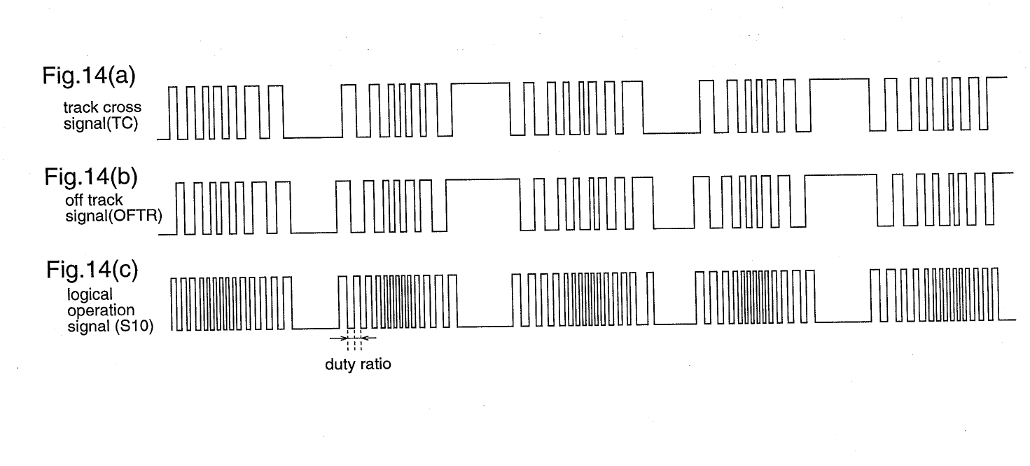

The control microcomputer 16 judges the reliability of the direction detection signal DIR on the basis of the measurement result S11 of the duty ratio of the logical operation signal S10. FIG. 14 is a diagram illustrating the relationship between the track cross signal TC and the off-track signal OFTR, and the duty ratio of the logical operation signal S10 in the case where the tracking control is off and the lens is fixed, wherein 14(a) shows the track cross signal TC, 14(b) shows the off-track signal OFTR, and 14(c) shows the logical operation signal S10.

In the optical disk device 1300, when the track cross signal TC and the off-track signal OFTR are correctly outputted, the phase difference between the track cross signal TC and the off-track signal OFTR is about 90 deg, and therefore, the duty ratio of the logical operation signal S10 has a waveform close to 50%.

When the duty ratio measurement result S11 is within a range from 40% to 60%, it is judged by the control microcomputer 16 that the reliability of the direction detection signal DIR is high, and the judgment result S2 is output to the switching circuit 15. On the other hand, when the duty ratio measurement result S11 is outside the above-mentioned range, it is judged that the reliability of the direction detection signal DIR is low, and the judgment result S2 is output to the switching circuit 15.

When it is judged that the reliability of the direction detection signal DIR is high, a switching signal S3 indicating that the direction detection signal DIR is valid is output from the switching circuit 15 to the access circuit 12 and the tracking pull-in circuit 13, and consequently, the access circuit 12 performs counting of tracks and outputting of an acceleration pulse or a deceleration pulse on the basis of the direction detection signal DIR, thereby performing access control to the optical disk 1. Further, the tracking pull-in circuit 13 performs outputting of an acceleration pulse or a deceleration pulse on the basis of the direction detection signal DIR, thereby performing tracking pull-in control.

On the other hand, when it is judged that the reliability of the direction detection signal DIR is low, a control signal S3 indicating that the direction detection signal DIR is invalid is output from the switching circuit 15 to the access circuit 12 and the tracking pull-in circuit 13, and consequently, the access circuit 12 and the tracking pull-in circuit 13 perform access to the optical disk 1 and tracking pull-in control, respectively, without using the direction detection signal DIR.

As described above, according to the optical disk device of the sixth embodiment, the reliability of the light beam spot moving direction that is indicated by the direction detection signal is judged on the basis of the duty ratio of the logical operation signal that is obtained between the track cross signal and the off-track signal, and the direction detection signal is used for track search and tracking pull-in control only when the reliability thereof is high. Therefore, it is possible to realize safe and stable track search and tracking pull-in.

In the optical disk device according to the sixth embodiment, even when learning of the reliability of the direction detection signal is not performed when the optical disk device is initially started up, the reliability of the direction detection signal can be judged during the operation of the optical disk device, thereby reducing the initial start-up time.

### Embodiment 7

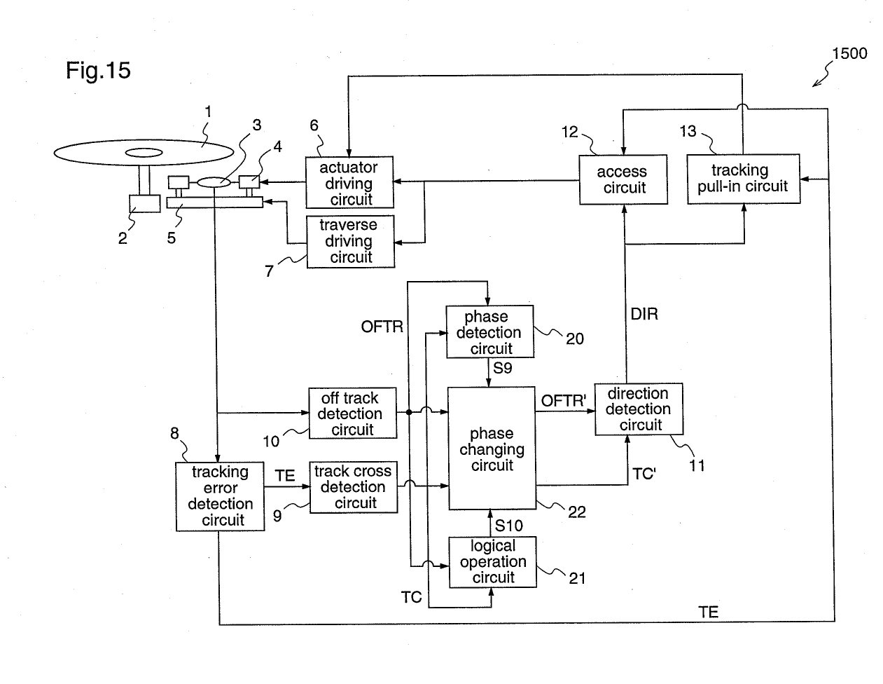

FIG. 15 is a block diagram illustrating the construction of an optical disk device 1500 according to a seventh embodiment of the present invention. In FIG. 15, the same constituents as those of the first to sixth embodiments are given the same reference numerals to omit the description thereof.

In FIG. 15, a phase changing circuit 22 adjusts the phases of the track cross signal TC and the off-track signal OFTR on the basis of the output from either the phase detection circuit 20 or the logical operation circuit 21.

Hereinafter, the phase changing circuit 22 will be described in more detail. Since the track cross detection circuit 9 and the off-track detection circuit 10 are constituted by different circuits, respectively, the phases of the actually detected track cross signal TC and the off-track signal OFTR might be different from their proper phases. For example, there is a case where, for the convenience of the circuit construction, the track cross signal TC is generated by an analog circuit while the off-track signal OFTR is generated by a digital circuit.

So, the phase changing circuit 22 adjusts either or both of the phases of the track cross signal TC and the off-track signal OFTR on the basis of the phase difference between the track cross signal TC and the off-track signal OFTR or the logical operation signal obtained between the track cross signal TC and the off-track signal OFTR to change the phase difference between the track cross signal TC and the off-track signal OFTR to the proper phase difference, thereby correctly detecting the direction detection signal DIR.

A phase correction value which is predetermined with considering the delays in the track cross detection circuit 9 and the off-track detection circuit 10 may be stored in the phase changing circuit 22, and the phases of the track cross signal TC and the off-track signal OFTR may be changed according to this value.

Next, the operation will be described.

When a light receiving signal from the light beam spot 3 is input to the tracking error detection circuit 8 and the off-track detection circuit 10, the tracking error detection circuit 8 detects a tracking error signal TE, and outputs the signal TE to the track cross detection circuit 9 and the tracking pull-in circuit 13. In the off-track detection circuit 10, an off-track signal OFTR is detected on the basis of the light receiving signal from the light beam spot 3, and output to the phase detection circuit 20, the logic operation circuit 21, and the phase changing circuit 22. In the track cross detection circuit 9, a track cross signal TC is detected on the basis of the tracking error signal TE, and output to the phase detection circuit 20, the logical operation circuit 21, and the phase changing circuit 22.

In the phase detection circuit 20, as described in the fifth embodiment, a phase difference between the track cross signal TC and the off-track signal OFTR is calculated, and input to the phase changing circuit 22. Further, in the logical operation circuit 21, as described in the sixth embodiment, a logical operation signal S10 between the track cross signal TC and the off-track signal OFTR is calculated, and input to the phase changing circuit 22.

In the phase changing circuit 22, phase lead amounts of the off-track signal OFTR and the track cross signal TC are obtained on the basis of either the phase difference detection signal S9 or the logical operation signal S10, and the phases of the track cross signal TC and the off-track signal OFTR are changed on the basis of the phase lead amounts so that the phase difference between the track cross signal TC and the off-track signal OFTR becomes about 90 deg.

The corrected track cross signal TC′ and off-track signal OFTR′ are output to the direction detection circuit 11, and the direction detection circuit 11 detects a direction detection signal DIR, and outputs the signal to the access circuit 12 and the tracking pull-in circuit 13.

Then, the access circuit 12 performs counting of tracks and outputting of an acceleration pulse or a deceleration pulse on the basis of the direction detection signal DIR, thereby performing access control to the optical disk 1. Further, the tracking pull-in circuit 13 performs outputting of an acceleration pulse or a deceleration pulse on the basis of the direction detection signal DIR, thereby performing tracking pull-in control.

As described above, according to the optical disk device of the seventh embodiment, the phases of the track cross-signal TC and the off-track signal OFTR are corrected so that the phase difference between the track cross signal TC and the off-track signal OFTR becomes a proper phase difference, by using either of the phase difference signal between the track cross signal TC and the off-track signal OFTR or the logical operation signal obtained between the track cross signal TC and the off-track signal OFTR, and the direction detection signal DIR is detected using the corrected track cross signal TC′ and off-track signal OFTR′. Therefore, a highly reliable direction detection signal can be constantly obtained, thereby realizing safe and stable track search and tracking pull-in.

### Embodiment 8

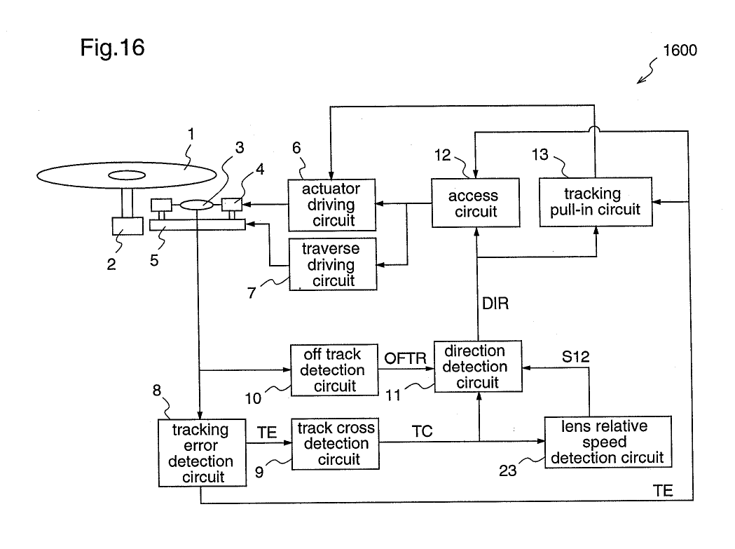

FIG. 16 is a block diagram illustrating the construction of an optical disk device 1600 according to an eighth embodiment of the present invention.

In FIG. 16, reference numeral 23 denotes a lens relative speed detection circuit for detecting a relative speed of the light beam spot 3 to the optical disk 1 on the basis of the track cross signal TC. When the relative speed of the light beam spot 3 to the optical disk 1 exceeds a predetermined speed, the lens relative speed detection circuit 23 outputs a hold signal S12 which instructs the direction detection circuit 11 to hold the output of the direction detection signal DIR. The lens relative speed detection circuit 23 may detect the relative speed of the light beam spot 3 to the optical disk 1 on the basis of either the tracking error signal TE or the off-track signal OFTR. Further, in FIG. 16, the same constituents as those of the first embodiment are given the same reference numerals to omit the description thereof.

Next, the operation will be described.

When a light receiving signal from the light beam spot 3 is input to the tracking error detection circuit 8 and the off-track detection circuit 10, the tracking error detection circuit 8 detects a tracking error signal TE, and outputs the signal TE to the track cross detection circuit 9 and the tracking pull-in circuit 13. Further, the off-track detection circuit 10 detects an off-track signal OFTR on the basis of the light-receiving signal from the light beam spot 3, and outputs the signal OFTR to the direction detection circuit 11. The track cross detection circuit 9 detects a track cross signal TC on the basis of the tracking error signal TE, and the track cross signal is output to the TC direction detection circuit 11 and the lens relative speed detection circuit.

The direction detection circuit 11 detects a direction detection signal DIR on the basis of the track cross signal TC and the off-track signal OFTR, and outputs the signal DIR to the access circuit 12 and the tracking pull-in circuit 13.

The lens relative speed detection circuit 23 detects the relative speed of the light beam spot 3 to the optical disk 1 on the basis of the period of the track cross signal TC, and when the speed exceeds a predetermined speed, the lens relative speed detection circuit 23 outputs a hold signal S12 to the direction detection circuit 11.

As the result, the direction detection signal DIR whose previous value is held is output from the direction detection circuit 11 to the access circuit 12 and the tracking pull-in circuit 13. Then, the access circuit 12 performs counting of tracks and outputting of an acceleration pulse or a deceleration pulse on the basis of the direction detection signal DIR, thereby performing access control to the optical disk 1. Further, the tracking pull-in circuit 13 performs outputting of an acceleration pulse or a deceleration pulse on the basis of the direction detection signal DIR, thereby performing tracking pull-in control.

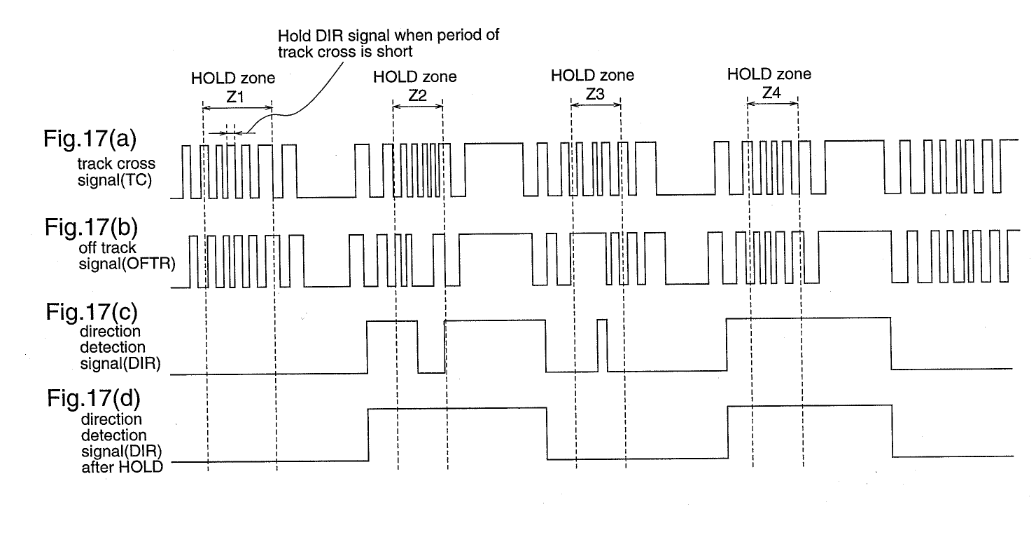

Next, the function and effect of the optical disk device 1600 according to the eighth embodiment will be described with reference to FIGS. 17(a) to 17(d).

FIG. 17(a) shows the track cross signal TC, 17(b) shows the off-track signal OFTR, 17(c) shows the direction detection signal DIR in the case where the hold signal S12 is not outputted, and 17(d) shows the direction detection signal DIR in the case where the output thereof is held. Further, HOLD zones Z1 to Z4 indicate periods during which the hold signal S12 is output from the lens relative speed detection circuit 23.

In the optical disk device 1600, when the relative speed of the light beam spot 3 to the optical disk 1 is high, i.e., when the period of the track cross signal is short, there is a possibility that the off-track signal OFTR is not correctly detected as shown by the HOLD zone Z2 or the HOLD zone Z3 in FIG. 17, which may result in noises in the direction detection signal DIR as shown in FIG. 17(c).

In this eighth embodiment, the lens relative speed detection circuit 23 detects the relative speed of the light beam spot 3 to the optical disk 1 on the basis of the period of the track cross signal TC, and holds the direction detection signal DIR when the relative speed exceeds a predetermined speed. Therefore, as shown in FIG. 17(d), the noise which occurs in the HOLD zone Z2 or the HOLD zone Z3 is reduced, and thereby a highly precise direction detection signal DIR can be output to the access circuit 12 and the tracking pull-in circuit 13.

As described above, according to the optical disk device of the eighth embodiment, the relative speed of the light beam spot to the optical disk is detected, and when the relative speed exceeds a predetermined speed, the direction detection signal is held to output the direction detection signal which has been detected most recently. Therefore, even when the moving speed of the light beam spot is low as in the seek operation and the track cross signal or the off-track signal cannot be correctly detected, the detection precision for the direction detection signal can be improved.

### Embodiment 9

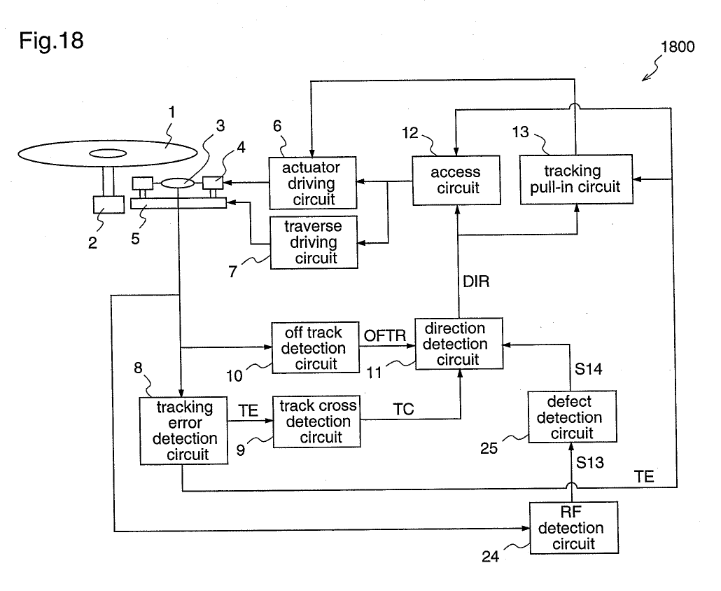

FIG. 18 is a block diagram illustrating the construction of an optical disk device 1800 according to a ninth embodiment of the present invention.

In FIG. 18, reference numeral 24 denotes an RF detection circuit for detecting a data signal on the optical disk 1.

Reference numeral 25 denotes a defect detection circuit for detecting a defect in the RF signal that is detected by the RF detection circuit 24, and outputting a defect signal S12 to the direction detection circuit 11 when a defect is detected.

Further, the directional detection circuit 11 according to the ninth embodiment holds the output of the direction detection signal DIR on receipt of the output of the defect signal S12 from the defect detection circuit 25. In FIG. 18, the same constituents as those of the first embodiment are given the same reference numerals to omit the description thereof.

Next, the operation will be described.

When a light receiving signal from the light beam spot 3 is input to the tracking error detection circuit 8, the off-track detection circuit 10, and the RF detection circuit 24, the tracking error detection circuit 8 detects a tracking error signal TE, and then the track cross detection circuit 9 detects a track cross signal TC on the basis of the tracking error signal TE and outputs the signal TC to the direction detection circuit 11. Then, the direction detection circuit 11 detects a direction detection signal DIR on the basis of the track cross signal TC and the off-track signal OFTR, and outputs the signal DIR to the access circuit 12 and the tracking pull-in circuit 13.

The RF detection circuit 24 detects an RF signal S13 from the light receiving signal from the light beam spot 3, and outputs the signal S13 to the defect detection circuit 25. When the defect detection circuit 25 detects a defect portion in the RF signal S13, the defect detection circuit 25 outputs a defect signal S12 to the direction detection circuit 11.

When the defect signal S12 is input to the direction detection circuit 11, the direction detection circuit 11 outputs the direction detection signal DIR whose previous value is held to the access circuit 12 and the tracking pull-in circuit 13. Then, the access circuit 12 performs counting of tracks and outputting of an acceleration pulse or a deceleration pulse on the basis of the direction detection signal DIR, thereby performing access control to the optical disk 1. Further, the tracking pull-in circuit 13 performs outputting of an acceleration pulse or a deceleration pulse on the basis of the direction detection signal DIR, thereby performing tracking pull-in control.

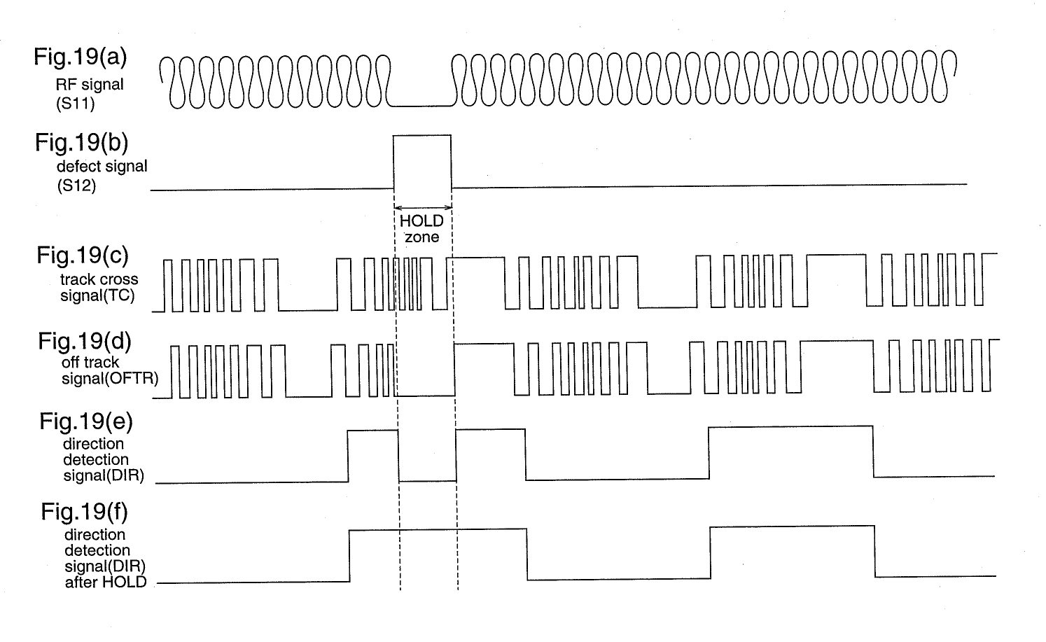

Next, the function and effect of the optical disk device 1800 according to the ninth embodiment will be described with reference to FIG. 19.

FIG. 19(a) shows the RF signal S13, 19(b) shows the defect signal S14, 19(c) shows the track cross signal TC, 19(d) shows the off-track signal OFTR, 19(e) shows the direction detection signal DIR which is not held, and 19(f) shows the direction detection signal DIR which is held.

The optical disk 1 may have a portion from which the data signal or the quantity of reflected light cannot be accurately obtained due to flaws or fingerprints. In such portion, the RF signal S13 has a missing portion in its waveform as shown in FIG. 19(a), and further, the track cross signal TC or the off-track signal OFTR cannot be accurately detected, resulting in an error in the direction detection signal DIR as shown in FIG. 19(e).

In the optical disk device 1800 according to the ninth embodiment, such defect portion on the optical disk 1 is detected from the RF detection signal S13, and the direction detection signal DIR is held in the defect portion on the disk 1. Therefore, no noise occurs in the defect portion on the disk 1 as shown in FIG. 19(f), and a highly precise direction detection signal can be output to the access circuit 12 and the tracking pull-in circuit 13.

As described above, according to the optical disk device of the ninth embodiment, a defect portion on the optical disk is detected, and the output of the direction detection signal is held in the defect portion on the optical disk while the direction detection signal which has been detected in the previous normal area is outputted. Therefore, even when the track cross signal or the off-track signal cannot be accurately detected due to flaws and contamination on the optical disk, a highly precise direction detection signal can be obtained, thereby realizing safe and stable track search and tracking pull-in.

### APPLICABILITY IN INDUSTRY

An optical disk device according to the present invention can realize stable track search control and stable tracking pull-in control, and it is useful in improving the quality of the optical disk device.

What is claims is:

1. An optical disk device comprising:
a light beam spot for irradiating a track on an optical disk with laser light to receive reflected light of the laser light;
an actuator for moving the light beam spot in a radial direction of the optical disk;
a traverse for moving the light beam spot and the actuator in the radial direction of the optical disk;
a tracking error detection circuit for detecting a tracking error signal on the basis of the reflected light of the laser light;
a track cross signal detection circuit for detecting a track cross signal on the basis of the tracking error signal;
an off-track signal detection circuit for detecting an off-track signal on the basis of the reflected light of the laser light;
a direction detection circuit for detecting a direction detection signal which indicates the moving direction of the light beam spot with respect to the optical disk, on the basis of the track cross signal and the off-track signal;
a track searching circuit performing track search for moving the light beam spot onto a desired track by driving the actuator and the traverse;
a tracking pull-in circuit performing tracking control for making the light beam spot follow a desired track by driving the actuator;
a duty ratio measurement circuit for measuring a duty ratio of the direction detection signal; and
a switching circuit for validating the direction detection signal when the duty ratio of the direction detection signal that is measured while the tracking control is off is within a predetermined range of threshold values, and invalidating the direction detection signal when the duty ratio of the direction detection signal is outside the predetermined range;
wherein, when the direction detection signal is valid, said track searching circuit performs the track search using the direction detection signal, and the tracking pull-in circuit performs the tracking control using the direction detection signal.

2. An optical disk device as defined in claim 1 wherein said switching circuit validates the direction detection signal when the duty ratio is within a range from 40% to 60%.

3. An optical disk device comprising:
a light beam spot for irradiating a track on an optical disk with laser light to receive reflected light of the laser light;
an actuator for moving the light beam spot in a radial direction of the optical disk;
a traverse for moving the light beam spot and the actuator in the radial direction of the optical disk;
a tracking error detection circuit for detecting a tracking error signal on the basis of the reflected light of the laser light;
a track cross signal detection circuit for detecting a track cross signal on the basis of the tracking error signal;
an off-track signal detection circuit for detecting an off-track signal on the basis of the reflected light of the laser light;
a direction detection circuit for detecting a direction detection signal which indicates the moving direction of the light beam spot with respect to the optical disk, on the basis of the track cross signal and the off-track signal;
a track searching circuit performing track search for moving the light beam spot onto a desired track by driving the actuator and the traverse;
a tracking pull-in circuit performing tracking control for making the light beam spot follow a desired track by driving the actuator;
a period measurement circuit for measuring a period of the direction detection signal; and
a switching circuit for validating the direction detection signal when the ratio of the period of the direction detection signal that is measured while the tracking control is off to the rotation period of the disk is within a predetermined range of threshold values, and invalidating the direction detection signal when the ratio is outside the predetermined range;
wherein, when the direction detection signal is valid, said track searching circuit performs the track search using the direction detection signal, and the tracking pull-in circuit performs the tracking control using the direction detection signal.

4. An optical disk device as defined in claim 3 wherein said switching circuit validates the direction detection signal when the ratio of the period of the direction detection signal to the rotation period of the disk is within a range from 90% to 110%.

5. An optical disk device comprising:
a light beam spot for irradiating a track on an optical disk with laser light to receive reflected light of the laser light;
an actuator for moving the light beam spot in a radial direction of the optical disk;
a traverse for moving the light beam spot and the actuator in the radial direction of the optical disk;
a tracking error detection circuit for detecting a tracking error signal on the basis of the reflected light of the laser light;
a track cross signal detection circuit for detecting a track cross signal on the basis of the tracking error signal;
an off-track signal detection circuit for detecting an off-track signal on the basis of the reflected light of the laser light;
a track searching circuit performing track search for moving the light beam spot onto a desired track by driving the actuator and the traverse;
a tracking pull-in circuit performing tracking control for making the light beam spot follow a desired track by driving the actuator;
a direction detection circuit for detecting a direction detection signal which indicates the moving direction of the light beam spot with respect to the optical disk, on the basis of the track cross signal and the off-track signal;
a lens shift circuit for shifting the light beam spot in the radial direction of the optical disk; and
a switching circuit for validating the direction detection signal when the direction in which the light beam spot is shifted by the lens shift circuit matches the moving direction of the light beam spot that is indicated by the direction detection signal, and invalidating the direction detection signal when these directions do not match;
wherein, when the direction detection signal is valid, said track searching circuit performs the track search using the direction detection signal, and the tracking pull-in circuit performs the tracking control using the direction detection signal.

6. An optical disk device comprising:
a light beam spot for irradiating a track on an optical disk with laser light to receive reflected light of the laser light;
an actuator for moving the light beam spot in a radial direction of the optical disk;
a traverse for moving the light beam spot and the actuator in the radial direction of the optical disk;
a tracking error detection circuit for detecting a tracking error signal on the basis of the reflected light of the laser light;
a track cross signal detection circuit for detecting a track cross signal on the basis of the tracking error signal;
an off-track signal detection circuit for detecting an off-track signal on the basis of the reflected light of the laser light;
a direction detection circuit for detecting a direction detection signal which indicates the moving direction of the light beam spot with respect to the optical disk, on the basis of the track cross signal and the off-track signal;
a track searching circuit performing track search for moving the light beam spot onto a desired track by driving the actuator and the traverse;
a tracking pull-in circuit performing tracking control for making the light beam spot follow a desired track by driving the actuator;
a track jump circuit for moving the light beam spot by one track on the optical disk; and
a switching circuit for validating the direction detection signal when the direction in which the light beam spot is moved by the track jump circuit matches the moving direction of the light beam spot that is indicated by the direction detection signal, and invalidating the direction detection signal when these directions do not match;
wherein, when the direction detection signal is valid, said track searching circuit performs the track search using the direction detection signal, and the tracking pull-in circuit performs the tracking control using the direction detection signal.

7. An optical disk device comprising:
a light beam spot for irradiating a track on an optical disk with laser light to receive reflected light of the laser light;
an actuator for moving the light beam spot in a radial direction of the optical disk;
a traverse for moving the light beam spot and the actuator in the radial direction of the optical disk;
a tracking error detection circuit for detecting a tracking error signal on the basis of the reflected light of the laser light;
a track cross signal detection circuit for detecting a track cross signal on the basis of the tracking error signal;
an off-track signal detection circuit for detecting an off-track signal on the basis of the reflected light of the laser light;
a direction detection circuit for detecting a direction detection signal which indicates the moving direction of the light beam spot with respect to the optical disk, on the basis of the track cross signal and the off-track signal;
a track searching circuit performing track search for moving the light beam spot onto a desired track by driving the actuator and the traverse;
a tracking pull-in circuit performing tracking control for making the light beam spot follow a desired track by driving the actuator;
a phase detection circuit for detecting a phase difference between the track cross signal and the off-track signal; and
a switching circuit for validating the direction detection signal when the phase difference between the track cross signal and the off-track signal is within a predetermined range of threshold values, and invalidating the direction detection signal when the phase difference is outside the predetermined range;
wherein, when the direction detection signal is valid, said track searching circuit performs the track search using the direction detection signal, and the tracking pull-in circuit performs the tracking control using the direction detection signal.

8. An optical disk device as defined in claim 7 wherein said switching circuit validates the direction detection signal when the phase difference is within a range from 80 deg to 100 deg.

9. An optical disk device comprising:
a light beam spot for irradiating a track on an optical disk with laser light to receive reflected light of the laser light;
an actuator for moving the light beam spot in a radial direction of the optical disk;
a traverse for moving the light beam spot and the actuator in the radial direction of the optical disk;
a tracking error detection circuit for detecting a tracking error signal on the basis of the reflected light of the laser light;
a track cross signal detection circuit for detecting a track cross signal on the basis of the tracking error signal;
an off-track signal detection circuit for detecting an off-track signal on the basis of the reflected light of the laser light;
a direction detection circuit for detecting a direction detection signal which indicates the moving direction of the light beam spot with respect to the optical disk, on the basis of the track cross signal and the off-track signal;
a track searching circuit performing track search for moving the light beam spot onto a desired track by driving the actuator and the traverse;
a tracking pull-in circuit performing tracking control for making the light beam spot follow a desired track by driving the actuator;
a logical operation circuit for operating an exclusive OR of the track cross signal and the off-track signal;
a duty ratio measurement circuit for measuring a duty ratio of the output signal from the logical operation circuit; and
a switching circuit for validating the direction detection signal when the duty ratio of the output signal from the logical operation circuit is within a predetermined range of threshold values, and invalidating the direction detection signal when the duty ratio is outside the predetermined range;
wherein, when the direction detection signal is valid, said track searching circuit performs the track search using the direction detection signal, and the tracking pull-in circuit performs the tracking control using the direction detection signal.

10. An optical disk device as defined in claim 9 wherein said switching circuit validates the direction detection signal when the duty ratio is within a range from 40% to 60%.

11. An optical disk device comprising:
a light beam spot for irradiating a track on an optical disk with laser light to receive reflected light of the laser light;
an actuator for moving the light beam spot in a radial direction of the optical disk;
a traverse for moving the light beam spot and the actuator in the radial direction of the optical disk;
a tracking error detection circuit for detecting a tracking error signal on the basis of the reflected light of the laser light;
a track cross signal detection circuit for detecting a track cross signal on the basis of the tracking error signal;
an off-track signal detection circuit for detecting an off-track signal on the basis of the reflected light of the laser light;
a phase changing circuit for changing the phase of the track cross signal or the off-track signal;
a direction detection circuit for detecting a direction detection signal which indicates the moving direction of the light beam spot with respect to the optical disk, on the basis of the track cross signal and the off-track signal which are outputted from the phase changing circuit;
a track searching circuit performing track search for moving the light beam spot onto a desired track by driving the actuator and the traverse, using the direction detection signal; and
a tracking pull-in circuit performing tracking control for making the light beam spot follow a desired track by driving the actuator, using the direction detection signal.

12. An optical disk device as defined in claim 11 further including a phase detection circuit for detecting a phase difference between the track cross signal and the off-track signal, and
said phase changing circuit changing the phase of the track cross signal or the off-track signal according to the phase difference between the track cross signal and the off-track signal.

13. An optical disk device as defined in claim 11 further including a logical operation circuit for operating an exclusive OR of the track cross signal and the off-track signal, and
said phase changing circuit changing the phase of the track cross signal or the off-track signal according to a duty ratio of an output signal from the logical operation circuit.

14. An optical disk device comprising:
a light beam spot for irradiating a track on an optical disk with laser light to receive reflected light of the laser light;
an actuator for moving the light beam spot in a radial direction of the optical disk;
a traverse for moving the light beam spot and the actuator in the radial direction of the optical disk;
a tracking error detection circuit for detecting a tracking error signal on the basis of the reflected light of the laser light;
a track cross signal detection circuit for detecting a track cross signal on the basis of the tracking error signal;
an off-track signal detection circuit for detecting an off-track signal on the basis of the reflected light of the laser light;
a direction detection circuit for detecting a direction detection signal which indicates the moving direction of the light beam spot with respect to the optical disk, on the basis of the track cross signal and the off-track signal;
a track searching circuit performing track search for moving the light beam spot onto a desired track by driving the actuator and the traverse, using the direction detection signal;
a tracking pull-in circuit performing tracking control for making the light beam spot follow a desired track by driving the actuator, using the direction detection signal; and
a lens relative speed detection circuit for detecting a relative speed of the light beam spot to the optical disk, on the basis of any of the tracking error signal, the track cross signal, and the off-track signal;
wherein said direction detection circuit holds the output of the direction detection signal when the relative speed of the light beam spot to the optical disk, which is detected by the lens relative speed detection circuit, is higher than a predetermined speed.

15. An optical disk device comprising:
a light beam spot for irradiating a track on an optical disk with laser light to receive reflected light of the laser light;
an actuator for moving the light beam spot in a radial direction of the optical disk;
a traverse for moving the light beam spot and the actuator in the radial direction of the optical disk;
a tracking error detection circuit for detecting a tracking error signal on the basis of the reflected light of the laser light;
a track cross signal detection circuit for detecting a track cross signal on the basis of the tracking error signal;
an off-track signal detection circuit for detecting an off-track signal on the basis of the reflected light of the laser light;
a direction detection circuit for detecting a direction detection signal which indicates the moving direction of the light beam spot with respect to the optical disk, on the basis of the track cross signal and the off-track signal;
a track searching circuit performing track search for moving the light beam spot onto a desired track by driving the actuator and the traverse, using the direction detection signal;
a tracking pull-in circuit performing tracking control for making the light beam spot follow a desired track by driving the actuator, using the direction detection signal; and
a defect detection circuit for detecting a defect on the optical disk;
wherein the direction detection circuit holds the output of the direction detection signal when a defect on the optical disk is detected by the defect detection circuit.
